(19) United States
(12) Patent Application Publication
(10) Pub. No.: US 2025/0375733 A1
(43) Pub. Date: Dec. 11, 2025

(54) PARABOLOIDAL AND CYLINDRICAL LOW-PRESSURE DROP SORBENT FILTER SYSTEM FOR FILTRATION, DIRECT AIR CAPTURE, OR POINT SOURCE CAPTURE

(71) Applicant: Nuxsen LLC, New York, NY (US)

(72) Inventors: Christopher R. Wight, New York, NY (US); Arthur J. Shih, Cambridge, MA (US)

(21) Appl. No.: 19/213,552

(22) Filed: May 20, 2025

Related U.S. Application Data
(60) Provisional application No. 63/657,515, filed on Jun. 7, 2024.

(51) Int. Cl. B01D 53/62; B01D 35/06; B01D 35/30; B01D 39/02

(52) U.S. Cl. CPC B01D 53/62; B01D 35/06; B01D 35/30; B01D 39/02; B01D 2101/005; B01D 2257/504

(57) ABSTRACT

The disclosure herein relates to a sorbent filter for filtering at least one of an axial, radial, and perpendicular flow of at least one of a gas, plasma, liquid, and solid particulates, the sorbent filter having a support material, a binder material for binding one or more active chemical material from a functional group to the support material and a filter body. The filter body includes a height of the sorbent filter longer than a radius of the filter body, the radius extending from a center axis through the filter body; an inner surface having a thickness less than the radius, and an outer surface in contact with at least one electrolyte and electrode for transmitting a voltage to the filter body.

### CROSS-REFERENCE TO RELATED APPLICATION

This application claims the benefit of U.S. Provisional Patent Application No. 63/657,515, filed Jun. 7, 2024, which is incorporated by reference herein in its entirety.

### TECHNICAL FIELD

The invention relates to the field of capture of gases and fluids.

### BACKGROUND

Direct air capture (DAC) is aimed at capturing carbon dioxide (CO₂) directly from ambient air, which is seen as a crucial tool in combating climate change by reducing atmospheric CO₂ levels. The DAC process typically involves three main steps: air contacting, CO₂ desorption, and CO₂ storage and utilization. During air contacting, ambient air is blown over a sorbent material that selectively captures CO₂. Sorbent filters are essential materials designed to absorb liquids or gases from their surroundings. Sorbent filters can be made up of various materials, including activated carbon, zeolites, silica gels, and clays. The captured CO₂ is then released from the sorbent using heat or chemical reactions, allowing the sorbent to be reused. The concentrated CO₂ can be stored underground through geological sequestration or used in industrial processes.

While DAC can effectively capture and reduce CO₂, Point source capture (PSC) methods can also capturing CO₂ emissions at their source, thereby offering more efficient as reduction of CO₂ emissions as CO₂ concatenations in flue gases are typically higher than in ambient air. PSC can be implemented through various methods, including pre-combustion capture, post-combustion capture, and oxy-fuel combustion. Pre-combustion capture involves removing CO₂ from fuels before combustion. Post-combustion capture captures CO₂ from flue gases after combustion, typically using sorbents. Oxy-fuel combustion burns fuels in pure oxygen, resulting in flue gases that are primarily CO₂ and water vapor, simplifying the capture process.

### SUMMARY

In one example, the disclosure includes a sorbent filter for filtering at least one of an axial, radial, and perpendicular flow of at least one of a gas, plasma, and liquid. The sorbent filter comprises: a support material; a binder material for binding one or more active chemical materials from a functional group to the support material; and a filter body having an open-ended or closed-ended paraboloid-shaped geometry comprising: a height of the filter body longer than a radius of the filter body, the radius extending from a center axis through the filter body; an inner surface having a thickness less than the radius; and an outer surface in contact with at least one electrolyte and electrode for transmitting a voltage to the filter body.

In another example, the disclosure includes a filter bundle housing for filtering carbon dioxide from a gaseous flow. The filter bundle housing comprises a plurality of open-ended or close-ended cylindrical filters disposed in a honeycomb or rectangular pattern, and a casing for containing the plurality of open-ended or close-ended filters, the casing having an inner portion for electrical and tubing components, and an outer portion for reactor tubing and reactor ports.

### BRIEF DESCRIPTION OF DRAWINGS

FIG. 1A is a three-dimensional front view of an example paraboloid-shaped sorbent in a rectangular compartment arranged in a 1×1 configuration, 2×2 configuration and 3×3 configuration.

FIG. 1B is a three-dimensional back view of an example paraboloid-shaped sorbent in a rectangular compartment arranged in a single 1×1 configuration, 2×2 configuration, and 3×3 configuration.

FIG. 2A is a three-dimensional front view of an example paraboloid-shaped sorbent in a rectangular compartment arranged in a single 1×1 configuration, 2×2 configuration, and 3×3 configuration.

FIG. 2B is a three-dimensional back view of an example paraboloid-shaped sorbent in a rectangular compartment arranged in a single 1×1 configuration, 2×2 configuration, and 3×3 configuration.

FIG. 3A is a three-dimensional rendering of the front view of an example silo-shaped sorbent in a rectangular compartment arranged in a single 1×1 configuration, 2×2 configuration, and 3×3 configuration.

FIG. 3B is a back view of an example silo-shaped sorbent in a rectangular compartment arranged in a single 1×1 configuration, 2×2 configuration, and 3×3 configuration.

FIG. 4 is a three-dimensional example of a hollow-fiber-shaped sorbent in a rectangular compartment arranged in a single 1×1 configuration, 2×2 configuration, and 3×3 configuration.

FIG. 5A is a three-dimensional front view example of a paraboloid-shaped sorbent in a rectangular compartment arranged in a single 1×1 configuration, 2×1 configuration, and 3×1 configuration.

FIG. 5B (B) back view of a paraboloid-shaped sorbent in a rectangular compartment arranged in a single 1×1 configuration, 2×1 configuration, and 3×1 configuration.

FIG. 6A is a three-dimensional example of a front view of a silo-shaped sorbent in a rectangular compartment arranged in a single 1×1 configuration, 2×1 configuration, and 3×1 configuration.

FIG. 6B is a three-dimensional example of a back view of a silo-shaped sorbent in a rectangular compartment arranged in a single 1×1 configuration, 2×1 configuration, and 3×1 configuration.

FIG. 7 is a three-dimensional example of a hollow-fiber-shaped sorbent in a rectangular compartment arranged in a single 1×1 configuration, 2×1 configuration, and 3×1 configuration.

FIG. 8A illustrates an example of the paraboloid-shaped, silo-shaped, or hollow-fiber shaped configurations packed in a square configuration.

FIG. 8B illustrates an example of the paraboloid-shaped, silo-shaped, or hollow-fiber shaped configurations packed in a hexagonal close packed configuration.

FIG. 9 illustrates an example of packing paraboloid-shaped, silo-shaped, or hollow-fiber shaped sorbent geometries, of different outer diameters, in circular containment reactor unit.

FIG. 10 is an illustration of one example of the process system.

FIG. 11 is a schematic of a closed-ended paraboloid (left), closed-ended silo-shaped (center), and closed-ended hollow-fiber-shaped (right) sorbent.

FIG. 12 is an illustration of the effect of the length (left) and outer radius (right) on the surface area. We assume that the radius is fixed at 0.0015 meter (left) or length fixed at 1 meter (right).

FIG. 13 is an illustration of the effect of the length (left) and outer radius (right) on the volume. We assume that the radius is fixed at 0.0015 m (left) or length fixed at 1 m (right).

FIG. 14 is a cross sectional view from the open part of the paraboloid geometry, in the direction of fluid flow.

FIG. 15 is an illustration of the effect of the number of parallel socks on the radius and thickness of the sock given a fixed reactor area of 1 m³. The thickness of the sock is filled with 1 mm diameter sorbent particles.

FIG. 16A is an illustration of how the radius and thickness varies with paraboloid diameter.

FIG. 16B is an illustration of how the paraboloid length varies with the paraboloid diameter. As the areal area increases, the sock diameter increases and the sock length decrease to maintain a reactor volume of 1 m³.

FIG. 17 is an illustration of the effect of paraboloid diameter on the CO₂ capture capacity.

FIG. 18 illustrates the effect of paraboloid length on the CO₂ capture capacity. The total volume of the reactor was maintained at 1 m³.

FIG. 19 illustrates the effect of the number of parallel closed-ended hollow-fiber sorbents on its radius and thickness given a fixed inlet area of 1 m³.

FIG. 20A illustrates how the radius and varies with closed-ended hollow fiber diameter.

FIG. 20B illustrates how the length varies with sorbent diameter. As the reactor inlet area increases, the diameter increases and the length decrease to maintain a reactor volume of 1 m³.

FIG. 21 illustrates the effect of closed-ended hollow fiber diameter on the CO₂ capture capacity. The total volume of the reactor was maintained at 1 m³.

FIG. 22 illustrates the effect of closed-ended hollow fiber length on the CO₂ capture capacity. The total volume of the reactor was maintained at 1 m³.

FIG. 23 is a schematic and dimensions of an open-ended hollow-fiber sorbent.

FIG. 24 illustrates the effect of the inner diameter % of the outer diameter on the volume taken up by sorbent in a 1 m³ reactor.

FIG. 25 illustrates the effect of the outer diameter, given an inner diameter of 0%, 20%, 50%, or 80% of the outer diameter, on the total exposed surface area of the sorbent.

FIG. 26 illustrates the effect of the outer diameter, given an inner diameter of 0%, 20%, 50%, or 80% of the outer diameter, on the length of the sorbent required to maintain a pressure drop of 150 Pa.

FIG. 27 illustrates the cross-section of a representative hollow fiber bundle in a triangular close-packed configuration.

FIG. 28 illustrates an example of how electrochemistry can be used to modulate electron densities in a sorbent to capture and release carbon dioxide.

FIG. 29 illustrates an example of arranging the sorbent geometry.

FIG. 30 illustrates the effect of the sorbent outer diameter on the n×n configuration (top). The effect of the sorbent length on the n×n configuration (bottom).

FIG. 31 illustrates the effect of the exposed sorbent surface area on the n×n configuration (e.g., top chart) and the effect of the exposed sorbent surface area on the fiber sorbent diameter (e.g., bottom chart).

FIG. 32 illustrates the volume of the carbon dioxide capture sorbent electrode (solid line) and the membrane and counter electrode (dotted line) as a function of the sorbent inner diameter.

FIG. 33 is a schematic of a controller, according to one example.

### DETAILED DESCRIPTION

The descriptions, illustrations, and examples in the present disclosure are given by illustration only and are by no means a limitation. The descriptions, illustrations, and examples are described and discussed in such a way that one skilled in the art may understand and appreciate the principles and practices of the disclosure. Various modifications such as substitutions, additions, rearrangements, may be made that remain potential applications of the disclosed processes.

The disclosure herein relates to open-ended and closed-ended paraboloids, silo-shaped, conical-shaped, or cylindrical-shaped sorbent filter geometries (herein “geometries”) designed for low-pressure drop as a stream of gas or liquid is flown through. These geometries may be configured as single units, units in a sequence, parallel bundles, crisscrossed bundles, or weaved bundles. These geometries may be activated for adsorption or desorption of carbon dioxide or other chemical compound(s) by heat, pressure, vacuum, or electrochemically activated by means of an electrolyte and electrode(s) on its inner and/or outer surface.

Atmospheric carbon dioxide has increased from 300 to >420 parts per million (ppm) over the past 200 years. This increase in carbon dioxide has been linked to ocean acidification, climate change, and extreme weather events, and is an imminent threat to global ecosystems and human society. To revert this increase in carbon dioxide in the atmosphere, society must not only stop or slow anthropogenic carbon dioxide emissions, but also deploy technologies to remove carbon dioxide directly from the atmosphere.

Carbon capture technologies can capture and remove carbon dioxide directly from carbon dioxide emitting processes (i.e. point source capture), or from diluted ambient sources (i.e. direct air or ocean capture). In point source capture, carbon dioxide is typically captured from process exhaust gases, which often contain carbon dioxide on the order of several percent (several 10,000 s of ppm). In contrast, direct air capture (DAC) and direct ocean capture (DOC) captures carbon dioxide from the air and ocean, respectively. The atmosphere currently contains around 420 ppm carbon dioxide, approximately 2 to 3 orders of magnitude lower than in point source applications. This difference in carbon dioxide concentrations is responsible for one of the biggest challenges of DAC technologies, resulting in drastically slower carbon dioxide uptake rates and capacities.

Potential technologies to capture carbon dioxide from the atmosphere come in a variety of forms, including membrane separations, physical sorbents, and biological methods. Membrane separations use engineered membranes selectively permeable to carbon dioxide to produce a product stream rich in carbon dioxide. Biological methods typically involve utilizing biomass with capability to uptake and chemically convert carbon dioxide, such as plants, trees, and algae. Physical sorbents can be liquid or solid, and utilize chemicals with specific affinity to carbon dioxide to selectively adsorb carbon dioxide from the air. The adsorbed carbon dioxide is then desorbed and collected for downstream applications or sequestration. Examples of biological methods include bioengineering plants to uptake more carbon dioxide, then sequestering the dehydrated plants directly or as biochar. Examples of physical sorbents include liquids and slurries, solid metal (hydr) oxides, typically alkali and alkaline-earth (hydr) oxides, solids functionalized with amines 14-21, zeolites 22-24, metal organic frameworks (MOFs), among others.

After uptake of carbon dioxide (CO₂), the desorption process can occur continuously with adsorption, resulting in a steady-state process, or as a separate step, resulting in a step-wise cyclical process. Steady-state processes continuously uptake CO₂ at one location in the process simultaneously while continuously desorb carbon dioxide in a separate location. Examples of steady-state continuous processes include trickle bed reactors, fluidized bed reactors, slurry aerators, and dual-flow systems. Step-wise cyclical processes are designed to uptake CO₂ in using a sorbent, then desorb CO₂ from the same sorbent once the sorbent is saturated. The sorbent in these step-wise processes may be contained in the same sorbent during adsorption and desorption, and/or physically transported between different units to facilitate transport carbon dioxide adsorption or desorption. These systems typically utilize valves or gate-like mechanical processes to isolate and toggle the chamber between adsorption and desorption. Examples of step-wise cyclical processes include mechanical revolvers and simulated moving beds. A number of carbon dioxide desorption strategies have been proposed and studied, including thermal, solar heat, vacuum, steam, electrochemical, microwave 1, or combinations(s) thereof, among others.

The uptake of carbon dioxide can occur in the presence of naturally produced convection, typically natural wind, or externally produced convection, typically performed with blowers. These blowers are used to force carbon dioxide rich gas into the sorbent to displace gas depleted of carbon dioxide. Because increased pressure drop increases the energy and consequently costs required to operate the blowers, numerous strategies and designs have been invented to decrease pressure drop. The first class of designs involve introducing larger flow paths for the gas to more easily flow using strategies such as increasing the sorbent particle size, constructing parallel sheets of thin sorbent, and utilizing monolith blocks. The second class of designs comprise decreasing the thickness of the sorbent bed and increasing its exposed areal surface area by engineering its geometry to zig-zag configurations of sorbent trays and hollow filters where gas flows radially to or from the center opening.

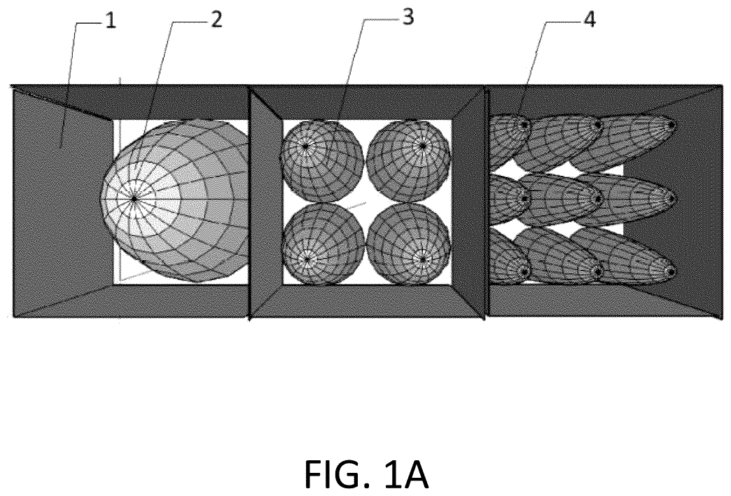

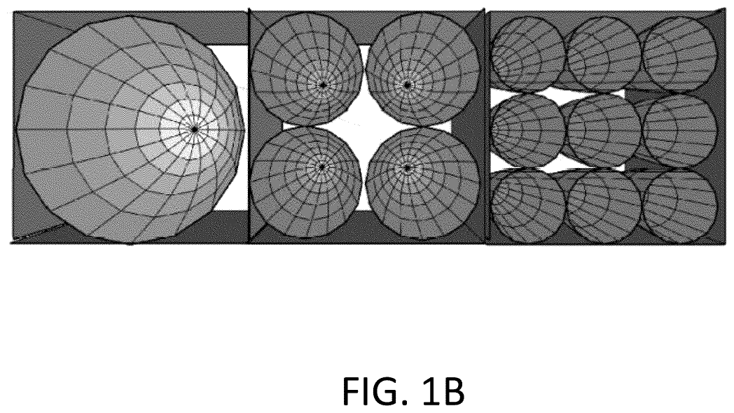

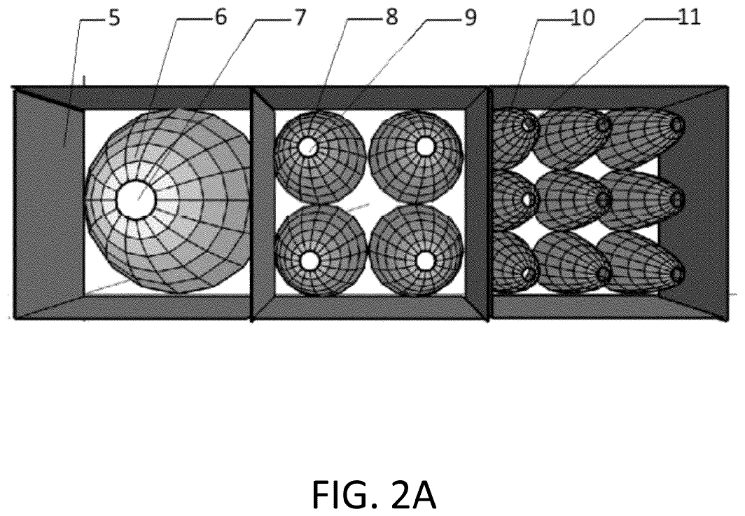

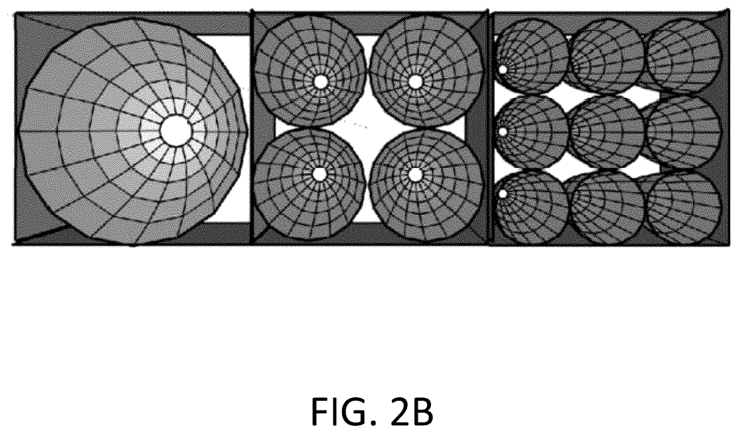

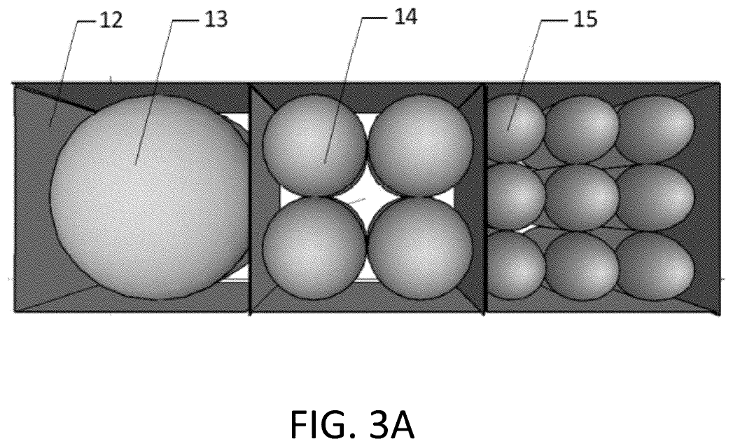

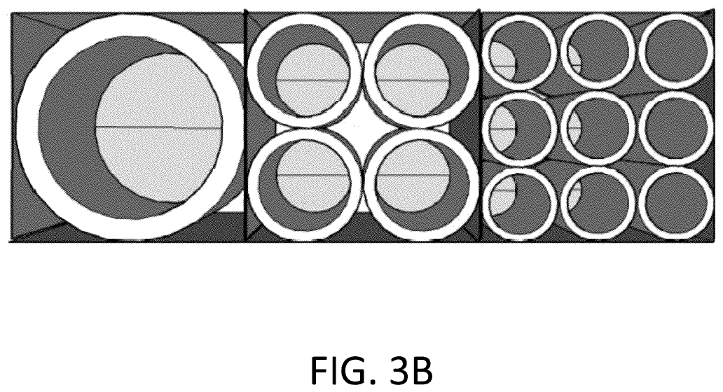

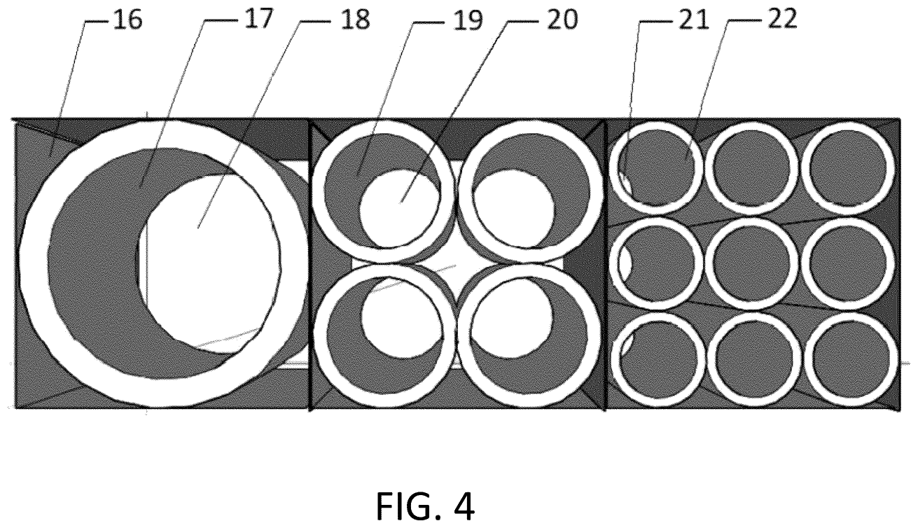

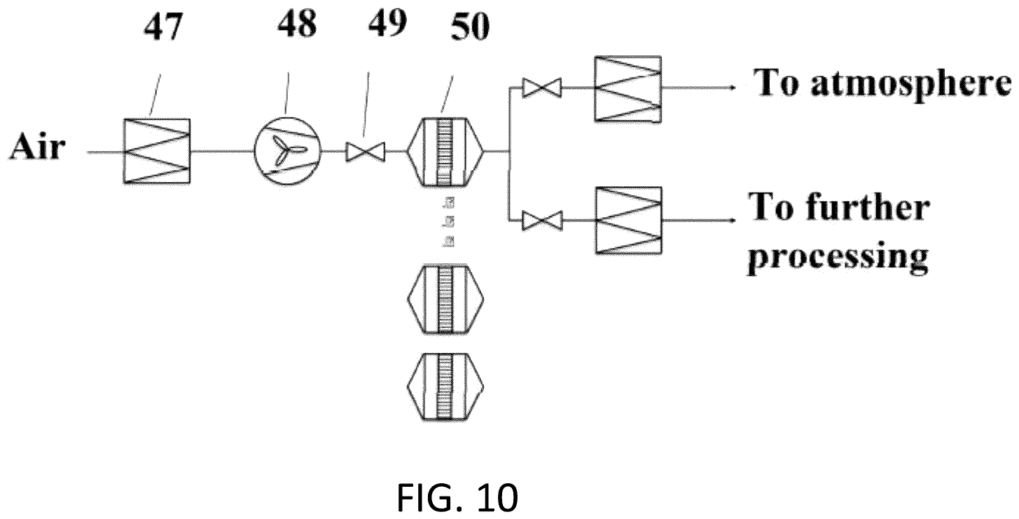

The filter system disclosed herein is a sorbent geometry intermediate between those of the first and second classes described above and is designed to decrease pressure drop. Instead of producing an ultimate stream of media which is clean, the filter system disclosed herein is directed to increasing the capture rate of each individual filter. The filter system can include closed-end paraboloids (FIG. 1), open-end paraboloids (FIG. 2), open-end and closed-end silo-shaped (FIG. 3), and/or hollow-fiber-shaped cylinder (FIG. 4) sorbent geometries designed for low-pressure drop as a stream of gas is flown through. These geometries may be configured as single units, sequential units, parallel bundles, crisscrossed bundles, weaved bundles, or randomly packed mats (FIGS. 1-9). These geometries may also be electrochemically activated by means of an electrolyte and electrode(s) on the inner and/or outer surface of the geometry. This sorbent would be integrated into a process designed to expose the sorbent to a stream of fluid (gas or liquid) to be treated (FIG. 10).

FIG. 1 is a three-dimensional rendering of the (A) front and (B) back view of a paraboloid-shaped sorbent in a rectangular compartment arranged in a single 1×1 configuration, 2×2 configuration, and 3×3 configuration, with similar n×n configurations to the limit of to ∞×∞ configurations. FIG. 1 includes reactor walls (1) containing sorbent, a single paraboloidal sorbent (2), four paraboloidal sorbents (3) arranged in a 2×2 configuration, and nine paraboloidal sorbents arranged in a 3×3 configuration (4). The example can include similar n×n configurations to the limit of to ∞×∞ configurations.

FIG. 2 is a three-dimensional rendering of the (A) front and (B) back view of a paraboloid-shaped sorbent in a rectangular compartment arranged in a single 1×1 configuration, 2×2 configuration, and 3×3 configuration, with similar n×n configurations to the limit of to ∞×∞ configurations. This configuration has a hole to enable lower pressure drops while still allowing the fluid sufficient time to contact the sorbent. FIG. 2 includes a reactor wall (5) containing the sorbent, a paraboloidal sorbent (6) with a hole at the tip (7), four paraboloidal sorbents arranged in a 2×2 configuration (8) with holes at each tip (9), and nine paraboloidal sorbents arranged in a 3×3 configuration (10) with holes at each tip (11). The example can include similar n×n configurations to the limit of to ∞×∞ configurations.

FIG. 3 is a three-dimensional rendering of the (A) front and (B) back view of a silo-shaped sorbent in a rectangular compartment arranged in a single 1×1 configuration, 2×2 configuration, and 3×3 configuration, with similar n×n configurations to the limit of to ∞×∞ configurations. FIG. 3 includes reactor walls (12) containing the sorbent, one single silo-shaped sorbent (13), four silo-shaped sorbents (14) arranged in a 2×2 configuration, nine silo-shaped sorbents (15) arranged in a 3×3 configuration. The example can include similar n×n configurations to the limit of to ∞×∞ configurations.

FIG. 4 is a three-dimensional rendering of a hollow-fiber-shaped sorbent in a rectangular compartment arranged in a single 1×1 configuration, 2×2 configuration, and 3×3 configuration, with similar n×n configurations to the limit of to ∞×∞ configurations. FIG. 4 includes reactor walls (16) containing the sorbent, a single hollow-fiber shaped sorbent (17), a hole through the hollow-fiber shaped sorbent (18), a four hollow-fiber shaped sorbent (19) arranged in a 2×2 configuration, a hole through the hollow-fiber shaped sorbent (20), a hole through the hollow-fiber shaped sorbent (21), and nine hollow-fiber shaped sorbents (22) arranged in a 3×3 configuration. The example can include similar n×n configurations to the limit of to ∞×∞ configurations.

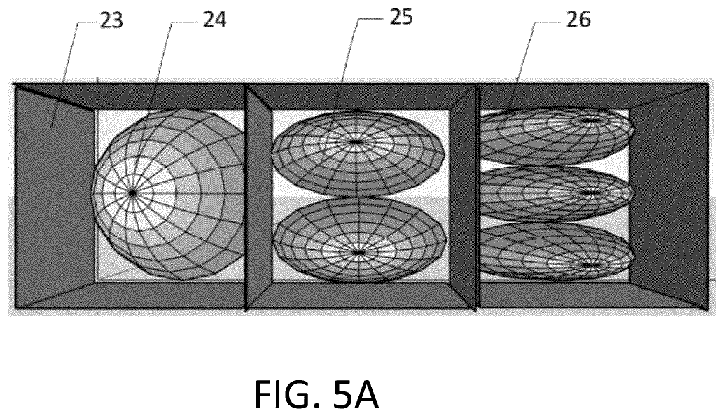

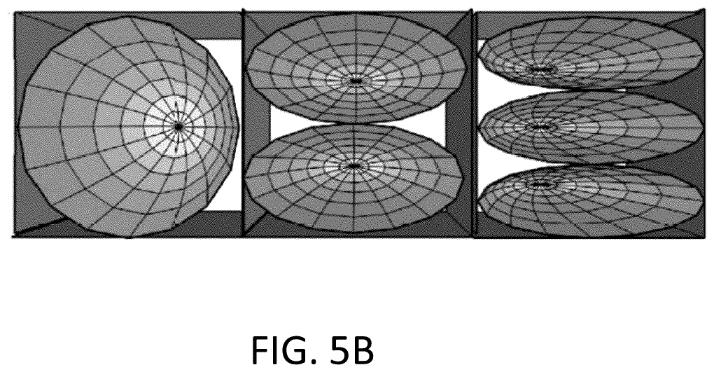

FIG. 5 is a three-dimensional rendering of the (A) front and (B) back view of a paraboloid-shaped sorbent in a rectangular compartment arranged in a single 1×1 configuration, 2×1 configuration, and 3×1 configuration, with similar m×n configurations to the limit of to ∞×∞ configurations. FIG. 5 includes a reactor wall (23) containing the sorbent, a single parapodial sorbent (24), two flattened paraboloidal sorbents (25) arranged in a 2×1 configuration, three flattened paraboloidal sorbents (26) arranged in a 3×1 configuration. The example can include similar n×n configurations to the limit of to ∞×∞ configurations.

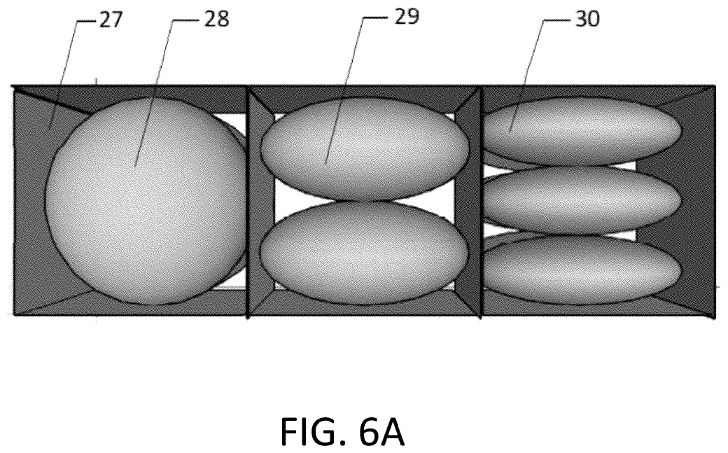

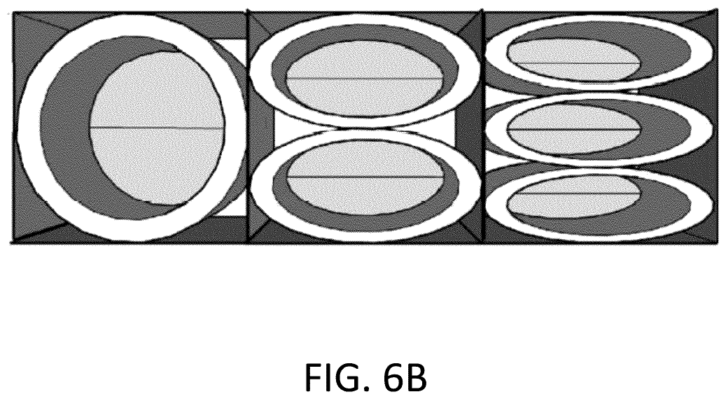

FIG. 6 is a three-dimensional rendering of the (A) front and (B) back view of a silo-shaped sorbent in a rectangular compartment arranged in a single 1×1 configuration, 2×1 configuration, and 3×1 configuration, with similar m×n configurations to the limit of to ∞×∞ configurations. FIG. 6 includes reactor walls (27) containing the sorbent, one single silo-shaped sorbent (28), two flattened silo-shaped sorbents (29) arranged in a 2×1 configuration, three flattened silo-shaped sorbents (30) arranged in a 3×1 configuration. The example can include similar n×n configurations to the limit of to ∞×∞ configurations.

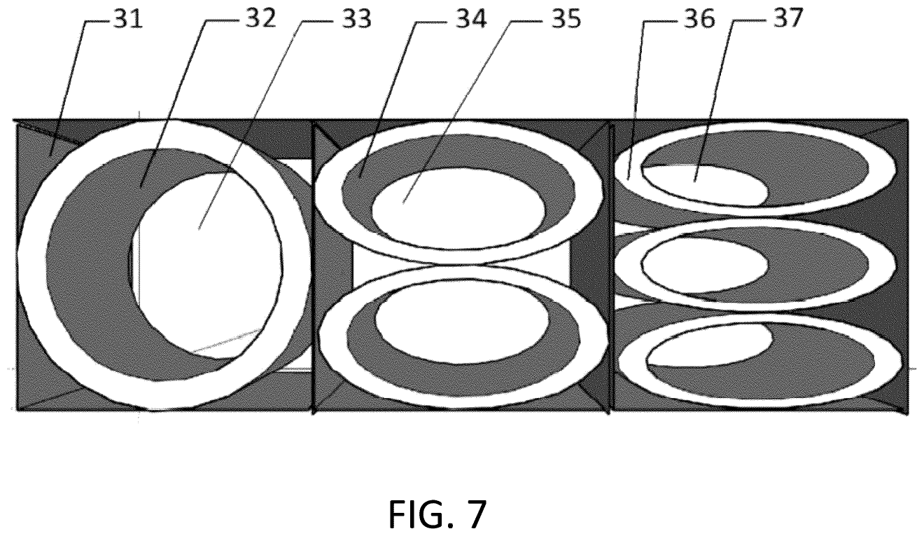

FIG. 7 is a three-dimensional rendering of a hollow-fiber-shaped sorbent in a rectangular compartment arranged in a single 1×1 configuration, 2×1 configuration, and 3×1 configuration, with similar m×n configurations to the limit of to ∞×∞ configurations. FIG. 7 includes reactor walls (31) containing the sorbent, one single hollow-fiber shaped sorbent (32), a hole through the hollow-fiber shaped sorbent (33), two flattened hollow-fiber shaped sorbents (34) arranged in a 2×1 configuration, a hole through the hollow-fiber shaped sorbent (35), three flattened hollow-fiber shaped sorbents (36) arranged in a 3×1 configuration, and a hole through the hollow-fiber shaped sorbent (37).

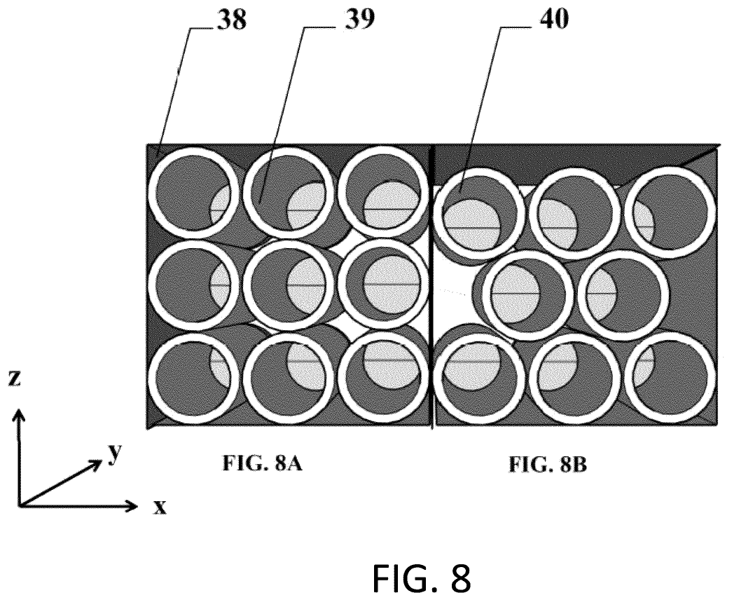

FIG. 8A illustrates an example of the paraboloid-shaped, silo-shaped, or hollow-fiber shaped configurations packed in a square configuration. FIG. 8A includes reactor walls (38) containing the sorbent and sorbents arranged in a square packed arrangement (39). FIG. 8B illustrates an example of the paraboloid-shaped, silo-shaped, or hollow-fiber shaped configurations packed in a hexagonal close packed configuration. FIG. 8B includes sorbents arranged in a triangular packed arrangement (40).

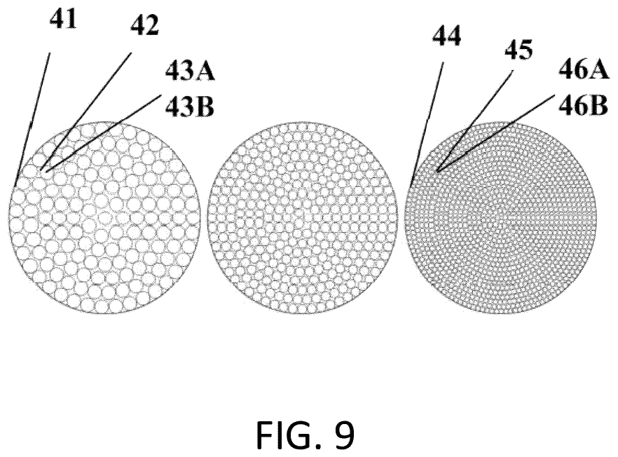

FIG. 9 illustrates an example of packing paraboloid-shaped, silo-shaped, or hollow-fiber shaped sorbent geometries, of different outer diameters, in circular containment reactor unit. FIG. 9 includes a reactor wall (41) containing sorbent (42), and a hole through the sorbent (43A) or alternatively electrochemical material (43B). FIG. 9 further includes a reactor wall (44), a sorbent (45), a hole through the sorbent (46A) or alternatively electrochemical material (46B).

The filter system can be composed of a series of filters separated by layers in which more fluid is permitted to pass into the system. In doing so, the system minimizes the overall pressure drop throughout the system as increased media is able to flow through and the filters are exposed to richer media since unfiltered media is introduced at each filter, thereby improving the capture rate of each individual filter.

FIG. 8 and FIG. 9 display some packing geometries. In FIG. 8, we display a rectangular box of defined height z, width x, and length y. If these sorbent geometries (e.g. closed-end paraboloids (FIG. 1), open-end paraboloids (FIG. 2), open-end and closed-end silo-shaped (FIG. 3), or open-end and closed-end hollow-fiber-shaped cylinder (FIG. 4)) are packed in the rectangular box (FIG. 8) such that their long axes are parallel lengthwise to the y-axis of the rectangular box, we see that the sorbent can be packed either as a square-packed configuration (FIG. 8A) or triangular-packed configuration (FIG. 8B). These configurations may be called arrays where the number of vertical rows are defined as the variable n, and the number of sorbent in each row defined as m. For brevity, the dimensions of the arrays will be referred to as n×m, where, as defined before, n is the number of rows of sorbent, and m is the number of sorbent in each row. To represent the limit of possible geometries of packed sorbent where the diameter of the sorbent becomes small compared to the container size, we may utilize the term ∞×∞. These packing configurations may be either square-packed, triangular-packed, or packed in configurations intermediate to the two. One possible embodiment of an intermediate configuration is presented in FIG. 9, where packing geometries of these sorbents into a cylindrical containment unit where the axis of the cylinder is parallel to the axes of the sorbent demonstrate that the sorbent can have packing geometries similar to and between those of triangular-packed and square-packed configurations.

FIG. 10 is an illustration of one example of the process system. FIG. 10 includes a filter (47) to remove particulates from an inlet stream, a blower/fan/pump (48) to transport fluid to/from sorbent modules, sorbent modules (49), valves (50) or alternatively, physical methods to control flow.

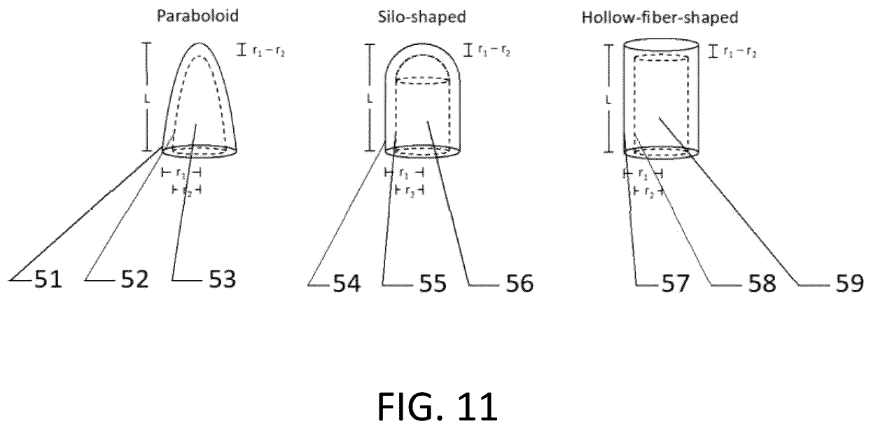

Volumes (V) and surface areas (A) of close-ended paraboloid, close-ended silo, and close-ended hollow-fiber shaped geometries using Equations 1 to 6. Relevant dimensions of these geometries are displayed in FIG. 11, where L represents the length of the geometry, r₁ represents the outer radius of the sorbent in at its widest point, r₂ represents the inner radius of the sorbent, and the difference between r₁ and r₂ (i.e. r₁-r₂) representing the thickness of the sorbent. FIG. 11 includes an outer surface area of hollow paraboloidal sorbent (51), an inner surface area of hollow paraboloidal sorbent (52), a hollow portion of paraboloidal sorbent (53), an outer surface area of hollow silo-shaped sorbent (54), an inner surface area of hollow silo-shaped sorbent (55), a hollow portion of silo-shaped sorbent (56), an outer surface area of hollow-fiber shaped sorbent (57), an inner surface area of a hollow-fiber shaped sorbent (58) and a hollow portion of a hollow-fiber shaped sorbent (59).

The volumes of these geometries may consist of a single block of sorbent, or a packing of smaller sorbent pieces (i.e. pellets, extrudates, etc.) held together into a bed in the shape of the geometry. Ultimately, these geometries in FIG. 11 enable high surface areas per volume, while allowing fluid to flow through the sorbent that makes up the solid portion of the geometry.

### Volume of Paraboloid Geometry:

$$V = \frac{1}{2} ( L π {r}_{1}^{2} - ( L - ( {r}_{1} - {r}_{2} ) ) π {r}_{2}^{2} ) \qquad ( Equation 1 )$$

### Volume of Silo-Shaped Geometry:

$$V = ( L - {r}_{1} ) ( π {r}_{1}^{2} - π {r}_{2}^{2} ) + \frac{4}{3} π ( {r}_{1}^{3} - {r}_{2}^{3} ) \qquad ( Equation 2 )$$

### Volume of Hollow-Fiber-Shaped Geometry:

$$V = L ( π {r}_{1}^{2} - π {r}_{2}^{2} ) + ( {r}_{1} - {r}_{2} ) ( π {r}_{2}^{2} ) \qquad ( Equation 3 )$$

### Surface Area of Paraboloid Geometry:

$$A = \frac{π {r}_{1}}{6 L} ( {( {r}_{1}^{2} + 4 {L}^{2} )}^{\frac{3}{2}} - {r}_{1}^{3} ) \qquad ( Equation 4 )$$

### Surface Area of Silo-Shaped Geometry:

$$A = ( L - {r}_{1} ) ( 2 π {r}_{1} ) + 2 π ( {r}_{1}^{2} ) \qquad ( Equation 5 )$$

### Surface Area of Hollow Cylinder Geometry:

$$A = L ( 2 π {r}_{1} ) + π {r}_{1}^{2} \qquad ( Equation 6 )$$

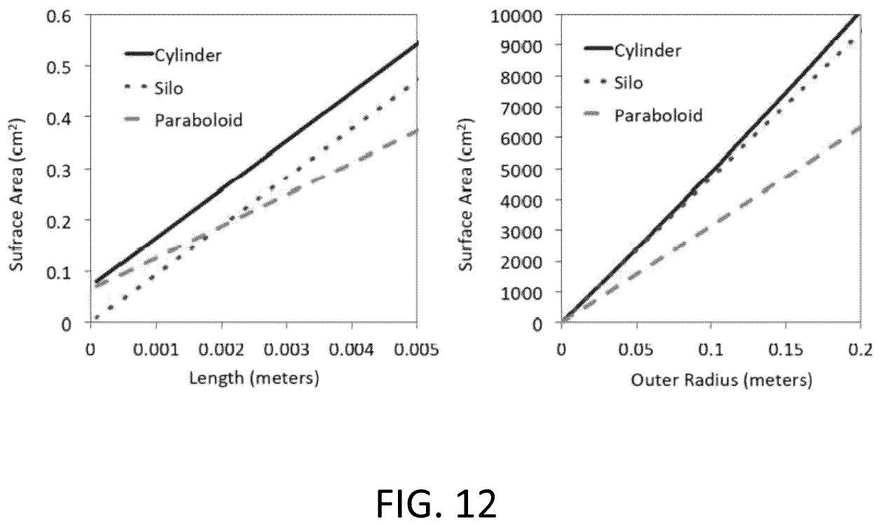

FIG. 12 illustrates the effect of radius and length on the surface area. Unless the geometric structures are really short (i.e. low valves of L), the paraboloid surface area is ˜⅔ that of hollow-fiber-shaped cylinder surface area, with the silo-shaped geometry surface area. The silo-shaped surface area is in between that of a paraboloid and cylinder. This means for the same reactor volume, cylinders geometries exhibit 50% more surface area, which is desirable for increased CO₂ uptake rates. We note that these surface areas are exclusively the exterior surface area of the sorbent. If the additional interior surface area is also included, the surface area will be approximately double given that r₁ and r₂ are similar. This would not change the relative ratios between the surface areas between the three geometries. Further, this area does not include the internal area of the sorbent itself.

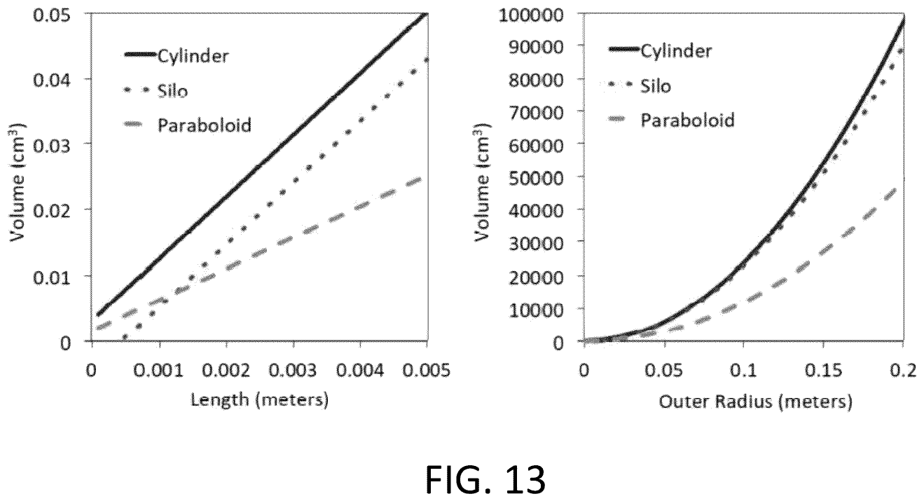

FIG. 13 illustrates the effect of radius and length on the volume. Unless the geometric structures are really short (i.e. low valves of L), the hollow-fiber-shaped cylinder volume is about 2 times greater than that of the paraboloid surface area. The silo-shaped volume is in between that of a paraboloid and cylinder.

Given a paraboloid-shaped sock whose widest cross section is a circle and 1 meter in diameter and is contained in a cylindrical reactor. The paraboloid-shaped sock is filled with sorbent pellets. Fluid flows into the sock from its widest cross section, through the sorbent pellets, then out through the other end of the cylinder. Equation 7 allows us to calculate the volume of the cylinder reactor. The variable r is the outer radius of the paraboloid, and L is the length of the cylindrical reactor, also equivalent to the length of the paraboloid sock.

Given a diameter of 1 m, a cylinder length of 1.273 m ensures the volume of the cylindrical reactor is 1 m³. Equation 8 allows us to calculate the surface area of the paraboloid, which is an input necessary for calculating the pressure drop. Like with Equation 7, the variable r is the outer radius of the paraboloid, and L is the length of the paraboloid sock. We find that the surface area of a single paraboloid in a cylinder of dimensions 1 meter in diameter and 1.273 m in length is 2.802 m².

### Volume of Cylindrical Reactor:

$${V}_{c y l i n d e r} = π {r}^{2} L \qquad ( Equation 7 )$$

### Surface Area of a Paraboloid:

$$A = \frac{π r}{6 {L}^{2}} ( {( {r}^{2} + 4 {L}^{2} )}^{\frac{3}{2}} - {r}^{3} ) \qquad ( Equation 8 )$$

$$A \frac{π ( 0.5 )}{6 {( 1.27324 )}^{2}} ( {( {( 0.5 )}^{2} + 4 {( 1.27324 )}^{2} )}^{\frac{3}{2}} - {( 0.5 )}^{3} ) = 2.8 \; 02 {m}^{2} \qquad ( Equation 9 )$$

To determine the thickness of the bed, we will utilize the Ergun Equation (Equation 10), which allows the calculation of the maximum thickness of the paraboloid sock necessary for fluid flowing across a bed of sorbent pellets (Equation 11). ΔL is the thickness comprised of sorbent pellets in the closed-ended paraboloid. ΔP is the pressure difference across the thickness of the paraboloid sock. μ is the dynamic viscosity of the fluid, dₚ is the average diameter of the sorbent pellets, q is the volumetric flow rate, ϵ is the void fraction of the sorbent packing, μ is the dynamic viscosity of the fluid, and ρ is the density of the fluid.

### Ergun Equation:

$$\frac{Δ P}{Δ L} = 150 ( \frac{μ v}{{d}_{p}^{2}} ) \frac{{( 1 - ϵ )}^{2}}{{ϵ}^{3}} + 1.75 ( \frac{ρ {v}^{2}}{{d}_{p}} ) \frac{( 1 - ϵ )}{{ϵ}^{3}} \qquad ( Equation 10 )$$

### Rearranging the Ergun Equation for Thickness (ΔL) of Paraboloid Geometry:

$$Δ L = \frac{Δ P}{\vert 150 ( \frac{μ v}{{d}_{p}^{2}} ) \frac{{( 1 - ϵ )}^{2}}{{ϵ}^{3}} + 1.75 ( \frac{ρ {v}^{2}}{{d}_{p}} ) \frac{( 1 - ϵ )}{{ϵ}^{3}} \vert} \qquad ( Equation 11 )$$

To determine the thickness of the pellet beds for a gas (for point-source or direct air capture), we used the properties of air at 15° C.

$$( {μ}_{air , {15}^{°} C .} = 18.03 \cdot {10}^{- 6} \frac{N s}{{m}^{2}} , {ρ}_{air , {15}^{°} C . , 1 atm} = 1.293 \frac{kg}{{m}^{3}} ) ,$$

average diameter of pellets to be 1 mm, (dₚ=1 mm), average void fraction of 0.375 (ϵ=0.375), a superficial linear velocity of 14.9 m s⁻¹ (v=14.86927 m s⁻¹, calculated from a flow rate of 150000 m³ hour⁻¹ and the paraboloid area), and a desired pressure drop of 150 Pa. These parameters give us a paraboloid thickness of 0.024 mm, a value that is 2.4% of the diameter of a sorbent pellet. These results indicate that one single close-ended paraboloid provides insufficient surface area to achieve a pressure drop of 150 Pa. These calculations suggest that a single layer of 1 mm pellets would result in a pressure drop of 6230 Pa.

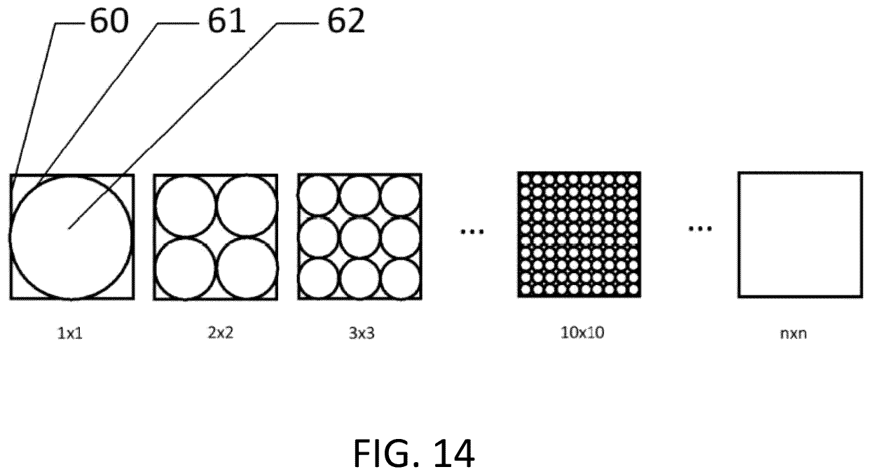

To increase the thickness of the paraboloid to more practical values, we increase the paraboloid's surface area per reactor volume by shrinking its diameter and arranging them in bundles. To demonstrate the feasibility of this configuration we define a geometry where the paraboloids are bundled in a square-packed configuration inside a square reactor whose total volume is 1 m³ (FIG. 1, FIG. 14). This allows us to define n, where n is the number paraboloids making up each row and column of the array. Thus, we can define N, the total number of paraboloids with Equation 12. We also define the area outside of the paraboloid circles is physically impermeable to fluid, so the fluid must enter from the large end of paraboloid and cross the paraboloid volume, which comprises of 1 mm diameter sorbent pellets. The circular end of a single paraboloid, called as the areal area (A_{areal,paraboloid}) and is defined by Equation 13. The total areal area of the reactor is equal to the areal area of each paraboloid multiplied by the total number of paraboloids, as defined by Equation 14. The height of the reactor (h_{paraboloid}) to achieve a reactor volume of 1 m₃ is defined by Equation 14. We note that this specific square-packed geometry is for demonstration purposes and these paraboloids may be bundled or arranged in other configurations, including, but not limited, to triangular-packed bundles, as demonstrated in FIG. 8, or in a circular fashion in a cylinder, as demonstrated in FIG. 9. Further, the geometry of the sorbent does not necessarily have to be a paraboloid.

### Number of Paraboloids, N, in a Square Bundle:

$$N = {n}^{2} \qquad ( Equation 12 )$$

Areal area of a single paraboloid sorbent, equivalent to area of one circle in FIG. 14

$${A}_{areal , paraboloid} = {π ( \frac{1 meter}{2 n} )}^{2} \qquad ( Equation 13 )$$

Areal area of the reactor, equivalent to area of all circles in each reactor in FIG. 14.

$${A}_{a r e a l} = N {A}_{a r e a l , p a r a b o l o i d} = N {π ( \frac{1 meter}{2 n} )}^{2} \qquad ( Equation 14 )$$

The height of the reactor (and paraboloid sorbent geometry):

$${h}_{p a r a b o l o i d} = \frac{1 {m}^{3}}{{A}_{a r e a l}} \qquad ( Equation 15 )$$

Using the same input parameters earlier for the single paraboloid sorbent calculation: properties of air at 15° C.

$$( {μ}_{air , {15}^{°} C .} = 18.03 \cdot {10}^{- 6} \frac{N s}{{m}^{2}} , {ρ}_{air , {15}^{°} C . , 1 atm} = 1.293 \frac{kg}{{m}^{3}} ) ,$$

average diameter of pellets to be 1 mm, (dₚ=1 mm), average void fraction of 0.375 (ϵ=0.375), a superficial linear velocity of 14.9 m s⁻¹ (v=14.86927 m s⁻¹, calculated from a flow rate of 150000 m³ hour⁻¹ and the paraboloid area), and a desired pressure drop of 150 Pa.

Table 1 illustrates how the pressure drop varies with the hollow-fiber sorbent length given a total flow rate of 150000 m3 h−1. We note that the total reactor volume was held constant at 1 m3, so a hollow-fiber sorbent length of 1 m would correspond to a reactor inlet area of 1 m3 and a hollow-fiber sorbent length of 0.2 m would correspond to a reactor inlet area of 5 m2.

TABLE 1

| Hollow-Fiber | Reactor | Pressure | Flow Rate Through | Flow Rate Through |
|---|---|---|---|---|
| Length | Inlet Area | Drop | Cylinder Pore | Triangular Pore |
| (m) | (m²) | (Pa) | (m3 h⁻¹) | (m³ h⁻¹) |
| 1 | 1.0 | 1033 | 118500 | 13500 |
| 0.3 | 3.3 | 310 | 118500 | 13500 |
| 0.2 | 5.0 | 207 | 118500 | 13500 |
| 0.145 | 6.9 | 150 | 118500 | 13500 |
| 0.14 | 7.1 | 145 | 118500 | 13500 |
| 0.1 | 10 | 103.3 | 118500 | 13500 |
| 0.02 | 50 | 20.7 | 118500 | 13500 |
| 0.01 | 100 | 10.3 | 118500 | 13500 |

FIG. 14 is a cross sectional view from the open part of the paraboloid geometry, in the direction of fluid flow. FIG. 14 includes reactor walls (60), one single hollow-fiber shaped sorbent (61), and a hole through the hollow-fiber shaped sorbent (62).

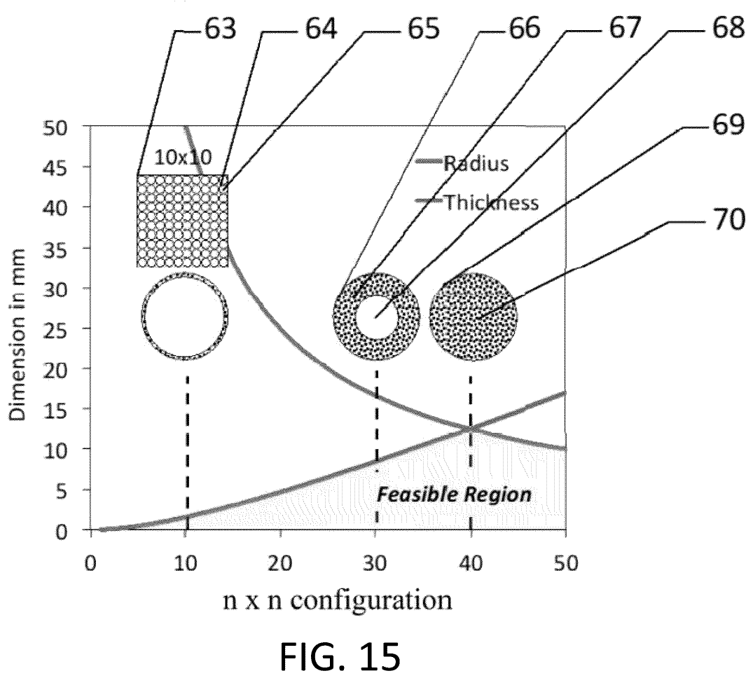

FIG. 15 displays the predicted radius and thickness of the paraboloid geometry (represented on the y-axis as “Dimension in mm”) as a function of the n, the number of paraboloids in each row of the square-packed configuration (represented on the x-axis as “n×n configuration”. We observe that as the number of paraboloids in the reactor increase, the radius of the paraboloid decreases (blue curve). This is expected when increasing the number of paraboloid sorbent in a reactor of fixed area. We also observe that the thickness of the paraboloid that contains the 1 mm diameter sorbent pellets increase with n (red curve).

At values of n lower than 40, we observe that the radius of the paraboloid is always larger than the thickness of the paraboloid, indicating that the paraboloid is hollow for bundles of paraboloid sorbents lower than 40×40. Right at a 40×40 configuration, we have a hollow paraboloid with a thin axial channel in the paraboloid in the middle for gas flow to access the 1 mm sorbent particles; this configuration maximizes the sorbent area exposed to the flowing fluid stream while also maximizing the amount of sorbent loaded. At values of n larger than 40, the thickness surpasses the radius, which is geometrically unfeasible. This physically means that the paraboloids are no longer hollow and are completely filled with 1 mm diameter sorbents with no axial hollow portion. Under these configurations, the pressure drop is lower than 150 Pa, which may be desirable if lower operating costs for operating the pump/blower/fan are desired. Taken together geometric feasible region that satisfies all the defined fluid properties and pressure drop are highlighted and labeled as “Feasible Region” in FIG. 15.

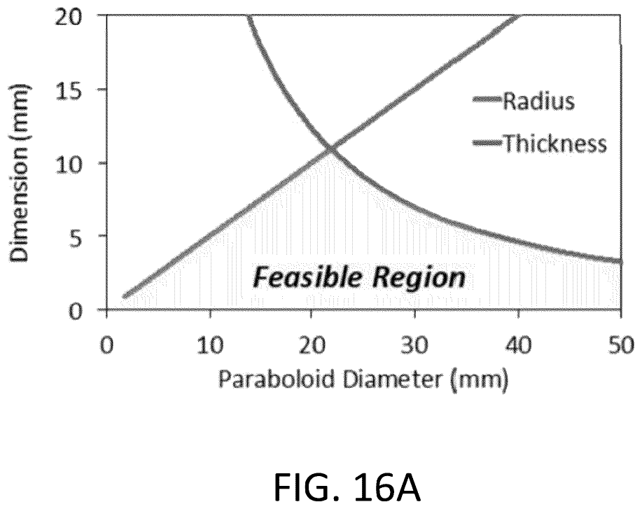

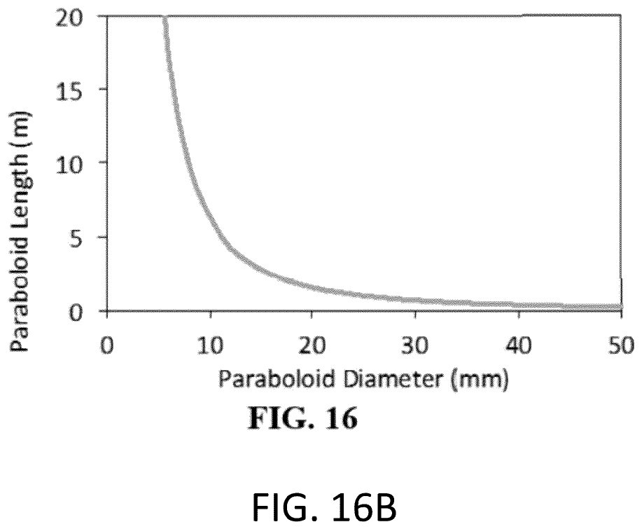

Thus far, we have assumed that the reactor inlet area is 1 m² with a total volume of 1 m³. We will now optimize the reactor performance by modulating the reactor inlet area (the area where fluid flows into the reactor) while keeping the total volume of the reactor at 1 m³. As the reactor inlet area increases, the length of the reactor will decrease to maintain a total volume of 1 m³. Conversely, as the reactor inlet area decreases, the length of the reactor will increase to maintain a total volume of 1 m³. FIG. 16A plots the paraboloid thickness and radius (represented on the y-axis as “Dimension in mm”) as a function of the paraboloid diameter (represented on the x-axis as “n×n configuration”. The paraboloid diameter is proportional to the length of the reactor inlet area. For example, a paraboloid diameter of 2.5 cm is equivalent a 1 m×1 cm reactor inlet area, with a height of 1 m; a paraboloid diameter of 20 cm is equivalent to an 8 m×8 m reactor inlet area (20 cm*40=8 m), with a height of 0.015625 m (1.56 cm).

FIG. 15 includes reactor walls (63) containing the sorbent geometry, the sorbent geometry in a 10×10 configuration (64), a possible hole through the sorbent geometry (65), an outer surface area of sorbent geometry (66), sorbent (67), a hollow portion of sorbent geometry (68), an outer surface area of sorbent geometry with no hollow portion (69), and sorbent geometry with no hollow portion (70).

Shown in FIG. 16A, we observe that the thickness of the 1 mm sorbent pellets in the paraboloids increases with increasing paraboloid diameter (and consequently reactor inlet area). The paraboloid diameter and paraboloid thickness intersect, at a diameter of ˜22 mm. This indicates that below 22 mm, the thickness is larger than the radius, which is geometrically unfeasible. In this scenario, the paraboloid geometries are completely filled with sorbent and exhibit pressure drops lower than 150 Pa, which can be used to modulate pressure drops and flow rates to improve efficiencies and operating costs of the pump/blower/fan. Above a paraboloid diameter of 22 mm, the paraboloid thickness is lower than its radius, resulting in a hollow paraboloid. This feasible area is labeled as “Feasible Region” in FIG. 16A and represents all possible radii and thicknesses where the pressure drop is 150 Pa or lower. FIG. 16B shows how the length of the reactor decreases with increasing paraboloid diameter, which is the natural trend expected when we lock the reactor volume to 1 m³.

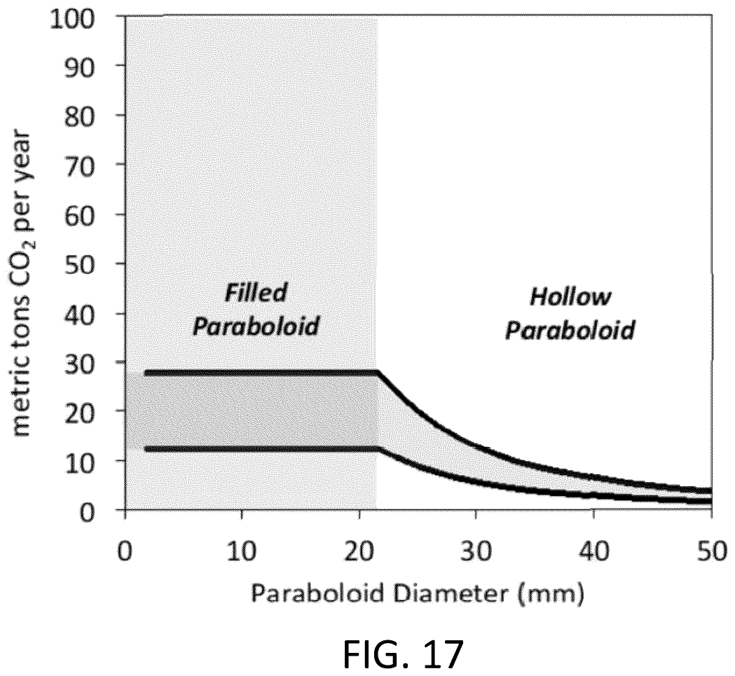

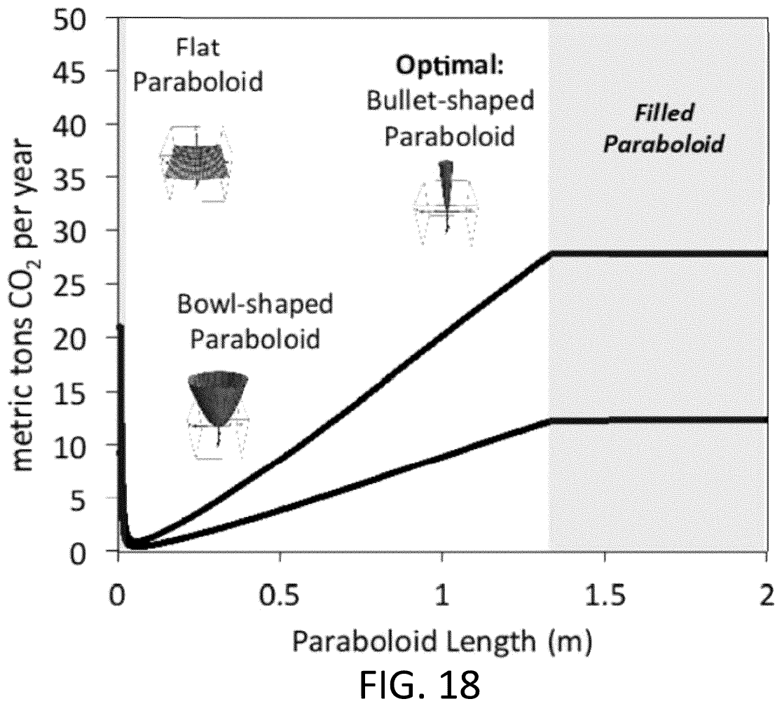

These geometries are proposed for filtration, point source capture, or direct air capture. To demonstrate the performance of these geometries for direct air capture, we first calculated the sorbent mass for all these configurations in FIG. 15 and FIG. 16 using an assumed sorbent density of 400 kg m⁻³. Using the sorbent mass, we then determined the amount of CO₂ uptake capacity by assuming a direct air capture capacity of between 0.3 and 0.7 mmol CO₂ per gram sorbent, a CO₂ uptake efficiency of 70%, and cycle time of 110 minutes. The results, shown in FIG. 17 and FIG. 18 were calculated for a 1 m³ reactor with a 40×40 configuration of paraboloids, with each paraboloid having a diameter of 22 mm.

FIG. 17 plots the yearly CO₂ uptake capacity as a function of paraboloid diameter. We see that the maximum possible uptake capacity occurs at lower paraboloid diameters less than 22 mm, which are filled completely with 1 mm sorbent pellets. FIG. 18 plots the yearly CO₂ uptake capacity, but as a function of the paraboloid length. FIG. 18 is intriguing and provides rationale on the advantages of open- and closed-ended paraboloids, silo-shaped, or hollow-fiber-shaped cylinder sorbent filter geometries. We observe that maximum CO₂ uptake occurs at the limits when the paraboloid lengths are short (<0.01 meters in FIG. 18) or long (>1.3 meters in FIG. 18). At intermediate paraboloid lengths, we observe a minimum in the CO₂ uptake capacity per year. This is because of wasted space in between the paraboloid structures that could be better utilized with sorbent. When the paraboloid lengths are short (<0.01 m), the geometry resembles that of a “flat paraboloid”, or flat sorbent bed, similar to patented sorbent tray configurations. These flat sorbent bed geometries can uptake 21 metric tons of CO₂ from the atmosphere per 1 m³ reactor. When the paraboloid lengths are long (>1.3 m), the geometry resembles narrow “bullet-shaped paraboloids,” and can uptake 28 metric tons of CO₂ from the atmosphere per 1 m³ reactor, 33% higher than the flat sorbent bed geometries. The two black curves and shaded area in between the two curves in FIGS. 17 and 18 represent the range when the sorbent exhibits uptake capacities between 0.3 and 0.7 mmol CO₂ per gram sorbent.

We repeat the same calculations performed for the paraboloid sorbent geometry on a hollow-fiber-shaped cylinder geometry. Only three changes were made in the governing equations and input parameters: (1) the volume of closed-ended hollow-fiber sorbent is calculated using Equation 16, (2) the outer surface area of the closed-ended hollow-fiber sorbent is calculated using Equation 17, (3) sorbent particulates that make up the plugged hollow-sorbent is 0.1 mm in diameter.

### Volume of Hollow Cylinder:

$$V = L ( π {r}_{1}^{2} - π {r}_{2}^{2} ) + ( {r}_{1} - {r}_{2} ) ( π {r}_{2}^{2} ) \qquad ( Equation 16 )$$

### Outer Surface Area of Hollow Cylinder:

$$A = L ( 2 π {r}_{1} ) + π {r}_{1}^{2} \qquad ( Equation 17 )$$

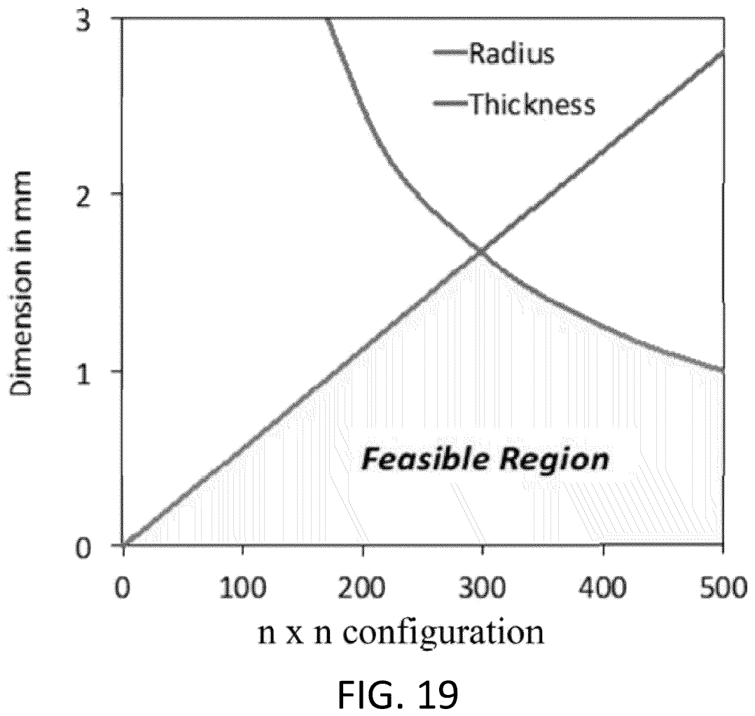

We find that a 300×300 bundle of closed-ended hollow fiber sorbents (FIG. 19). Bundles less than 300×300 are closed-ended hollow fibers where the thickness is lower than the radius (whose lengths are represented on the y-axis as “dimension in mm”). Bundles larger than 300×300 must be in only solid fibers whose thickness and radius are equal to that of the radius curve. The region labeled “Feasible Area” in FIG. 19 represents all possible radii and thicknesses where the pressure drop is 150 Pa or lower. As mentioned earlier with the paraboloid geometries, modulating the pressure drop and flow rates can be used to increase energy efficiency and decrease operating costs of the pump/blower/fans.

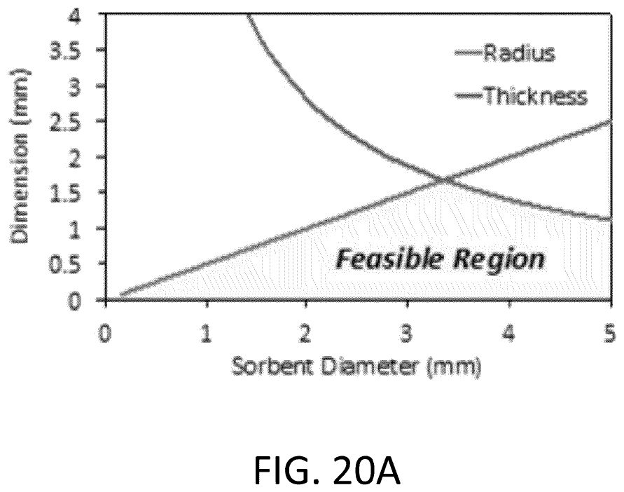

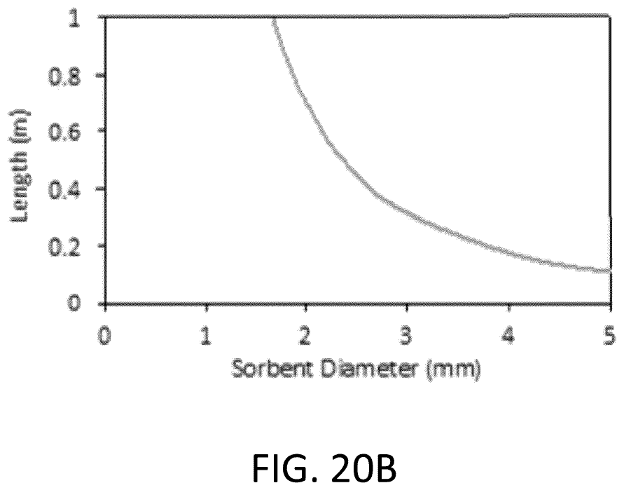

Using the optimized 300×300 bundle of closed-ended hollow fiber sorbents, we varied the inlet reactor area while maintain a reactor volume of 1 m³. Results shown in FIG. 20 demonstrate that closed-ended hollow fibers with diameters more than 3.3 mm are no longer hollow, but instead simply solid fibers. Closed-ended hollow fibers with diameters less than 3.3 mm are hollow. The area labeled as “Feasible Region” in FIG. 19A represents all possible radii and thicknesses where the pressure drop is 150 Pa or lower. FIG. 19B shows how the length of the reactor decreases with increasing paraboloid diameter, which is the natural trend expected when we lock the reactor volume to 1 m³.

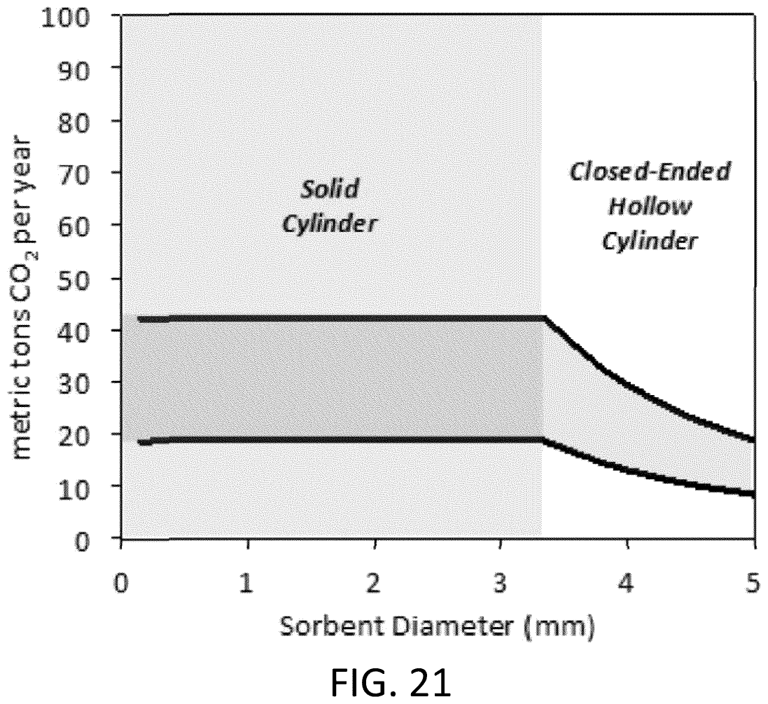

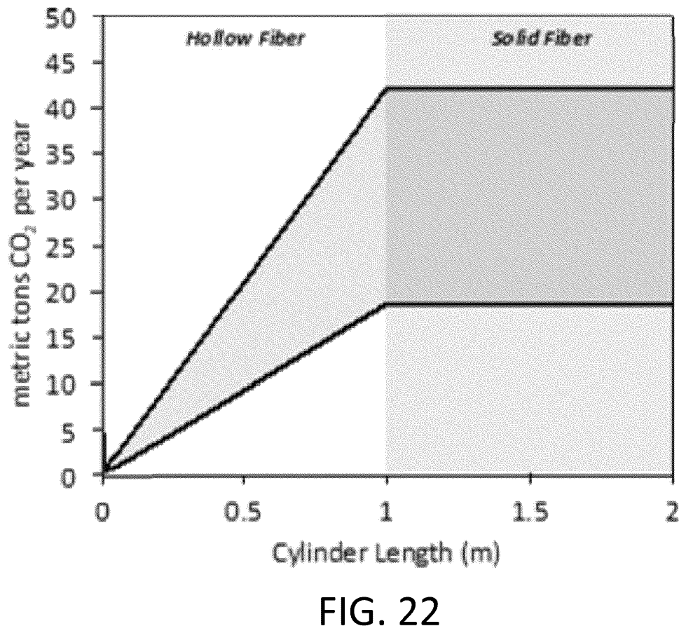

These geometries are proposed for filtration, point source capture, or direct air capture. To demonstrate the performance of these geometries for direct air capture, we first calculated the sorbent mass for all these configurations in FIG. 19 and FIG. 20 using an assumed sorbent density of 400 kg m⁻³. Using the sorbent mass, we then determined the amount of CO₂ uptake capacity by assuming a direct air capture capacity of between 0.3 and 0.7 mmol CO₂ per gram sorbent, a CO₂ uptake efficiency of 70%, and cycle time of 110 minutes. The results, shown in FIG. 21 and FIG. 22 were calculated for a 1 m³ reactor with a 300×300 configuration of closed-ended hollow fibers, with each having a diameter of 3.3 mm.

FIG. 21 plots the yearly CO₂ uptake capacity as a function of closed-ended hollow fiber diameter. We see that the maximum possible uptake capacity occurs at lower diameters less than 3.3 mm. FIG. 22 plots the yearly CO₂ uptake capacity, but as a function of the closed-ended hollow fiber length. FIG. 22 is intriguing in the same way FIG. 18 is intriguing in that it also provides rationale on the advantages of open- and closed-ended paraboloids, silo-shaped, or hollow-fiber-shaped cylinder sorbent filter geometries. We observe that maximum CO₂ uptake occurs at the limits when the paraboloid lengths are short (<0.001 meters in FIG. 22) or long (>1.0 meter in FIG. 22). At intermediate closed-ended hollow fiber lengths, we observe a minimum in the CO₂ uptake capacity per year. Like with the paraboloid geometry, this minimum is because of wasted space in between in the closed-ended hollow fiber structures that could have been better utilized with sorbent. When the closed-ended hollow fiber lengths are short (<0.001 m), the geometry resembles that of a flat sorbent bed, again similar to patented sorbent tray configurations. These flat sorbent bed geometries can uptake 31 metric tons of CO₂ from the atmosphere per 1 m³ reactor. When the closed-ended hollow fiber lengths are long (>1.0 m), the geometry is narrow and thin, and can uptake up to 42 metric tons of CO₂ from the atmosphere per 1 m³ reactor, 33% higher than the flat sorbent bed geometries. The two black curves and shaded area in between the two curves in FIGS. 21 and 22 represent the range when the sorbent exhibits uptake capacities between 0.3 and 0.7 mmol CO₂ per gram sorbent.

For direct air capture (DAC) systems, the largest operational costs are typically the air fans used to transport CO₂-rich air through the sorbent because of the extremely low concentration of CO₂ in the air. A technoeconomic study by the United States National Energy Technology Laboratory (NETL) estimated that air fans constitute of approximately 90% of all the energy required for operation 73, thus any efforts to decrease pressure drop while maintaining other parameters such as capture rate, capacity, and efficiency would significantly decrease the energy required to operate DAC systems. Decreasing the pressure drop, and thus operational energy, can be achieved by incorporating one or more holes at the outlet end of our paraboloid, silo-shaped, or hollow-fiber-shaped cylinder sorbent filter geometries, as shown in FIG. 2, FIG. 4, and FIG. 7. These geometries would decrease the pressure drop thus be termed as open-ended geometries.

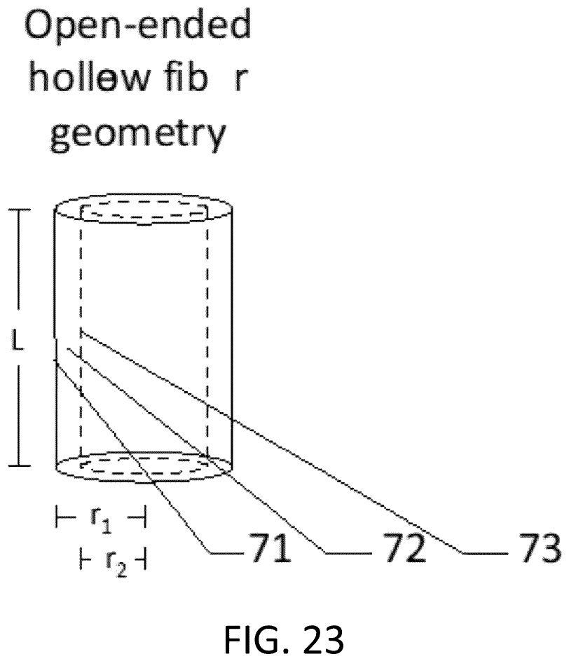

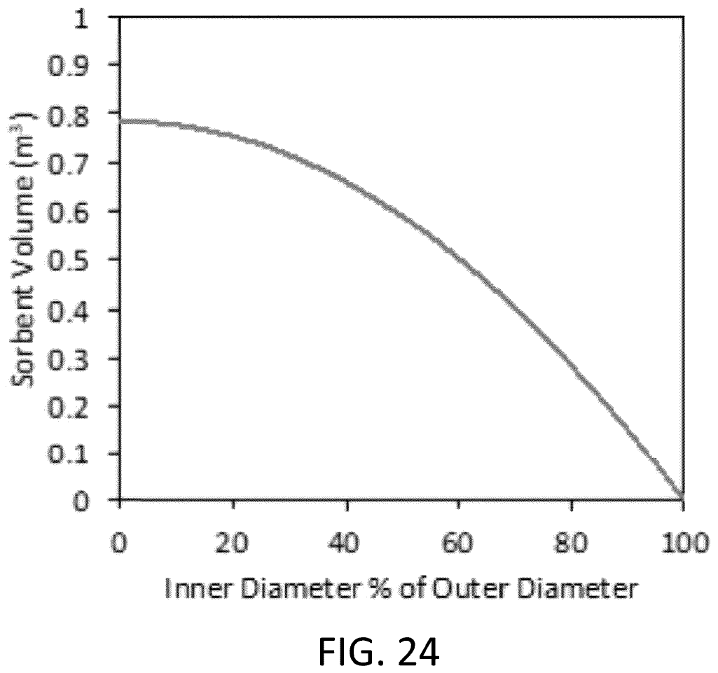

FIG. 23 illustrates an open-ended hollow-fiber-shaped cylinder sorbent. FIG. 23 includes an outer surface area of hollow-fiber shaped sorbent (71), sorbent (72), and an inner surface area of hollow-fiber shaped sorbent (73). The open-ended hollow fiber sorbent is arranged in a n×n square-packed configuration in FIG. 14 and exhibits a total reactor volume of 1 m³. Our results indicate that if the inner diameter is a fixed percent of the outer diameter, all n×n configurations result in the same sorbent loading, and thus theoretical maximum CO₂ uptake capacity. This is because each square unit cell exhibits the same fractions of sorbent and void space regardless of the unit cell size. Thus, the biggest factor that impacts maximum carbon capture capacity is the outer diameter of the sorbent, percentage of the inner diameter to the outer diameter, in addition to the packing configuration (FIG. 8, FIG. 9).

The highest sorbent loading possible for a square-packed configuration (FIG. 14) is when the inner radius is 0, essentially rendering the “hollow-fiber” into a “solid-fiber”. This configuration, however exhibits low surface area, potentially limiting CO₂ diffusion uptake rate by the sorbent. To maximize the exposed surface area, we observe that the inner diameter must be both small and almost equal to that of the outer diameter. However, this extreme example may be unfeasible as the sorbent volume drastically decreases zero in this limiting case. Further, manufacturing and mechanical stability of the sorbent would presumably be more unfeasible with these thinner hollow fiber sorbents.

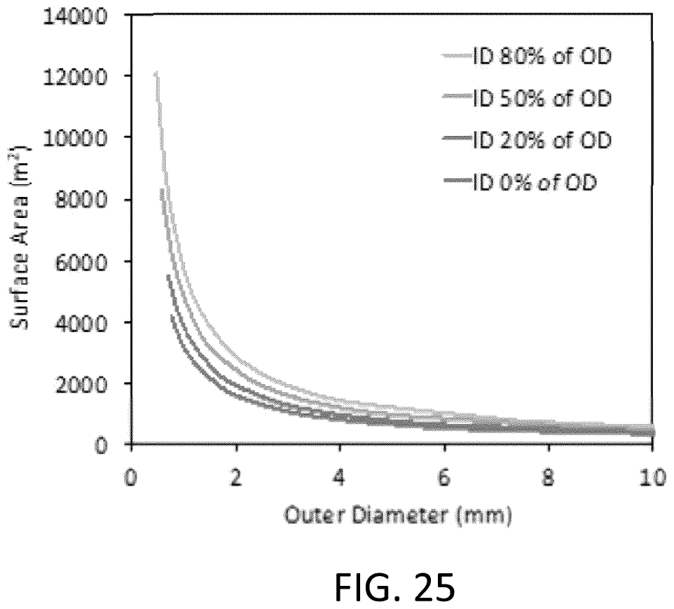

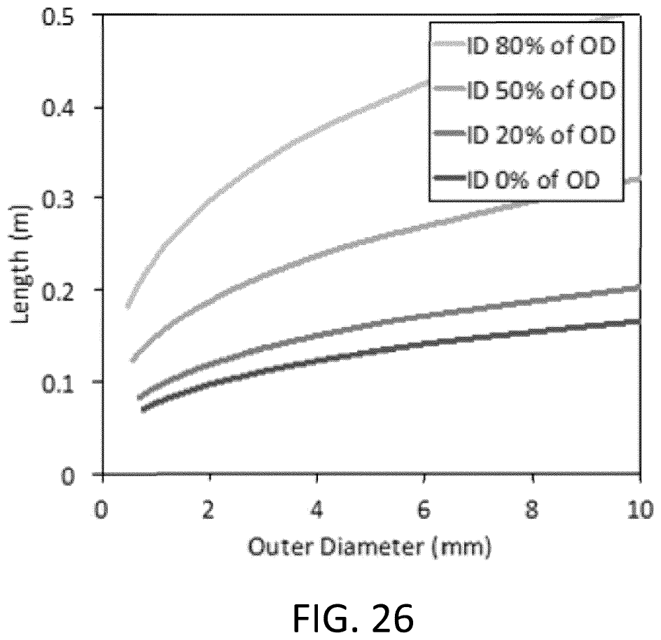

Demonstrated in FIG. 25, we observe that to maintain a pressure drop of 150 Pa, the length of the sorbent increases with increasing inner diameter to outer diameter ratio. This intuitively makes sense because larger cross sectional areas result in lower pressure drop per unit length, allowing a much longer sorbent before the pressure drop limit is reached. On the contrary, when there is no inner diameter (0% of the outer diameter), i.e. a solid cylindrical fiber, the lengths required to maintain a pressure drop of 150 Pa is much lower, which will be calculated in the next section.

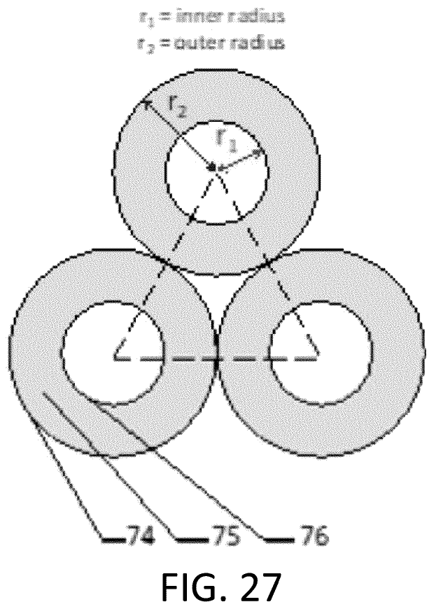

To calculate the lengths of hollow-fiber sorbents required to achieve a pressure drop of 150 Pa, we utilized a triangular close-packed geometry to maximize the sorbent loading per reactor volume (FIG. 27). FIG. 27 illustrates the cross-section of a representative hollow fiber bundle in a triangular close-packed configuration. FIG. 27 includes an outer surface area of hollow-fiber shaped sorbent (74), sorbent (75), and an inner surface area of hollow-fiber shaped sorbent (76).

Equations 18, 19, and 20 display formulas used to calculate the triangular close-packed unit cell volume, sorbent volume, volume fraction of sorbent (f), and mass of sorbent loaded (m_{sorbent}) respectively. r₁ and r₂ are the outer and inner radii of the hollow-fiber sorbent geometry. L is the length of the sorbent or reactor, V_{reactor} is the volume of the filtration reactor, and ρ_{V} is the volumetric density of the sorbent.

$$Unit Cell Volume = L \sqrt{3} {r}_{2}^{2} \qquad ( Equation 18 )$$

$$Sorbent Volume = \frac{L π ( {r}_{2}^{2} - {r}_{1}^{2} )}{2} \qquad ( Equation 19 )$$

$$f = Volume Fraction of Sorbent = \frac{Sorbent Volume}{Unit Cell Volume} = \frac{π}{2 \sqrt{3}} \frac{( {r}_{2}^{2} - {r}_{1}^{2} )}{{r}_{2}^{2}} \qquad ( Equation 20 )$$

$${m}_{s o r bent} = {ρ}_{V} {V}_{r eactor} f \qquad ( Equation 21 )$$

The volume fraction of the a reactor taken up by sorbent is calculated to be 0.73 using Equation 20, assuming a hollow-fiber outer diameter of 0.9 mm and inner diameter of 0.4 mm. Assuming a sorbent density of 400 kg m⁻³, a 1 m³ reactor will be able to contain 300 kg sorbent in the geometry of a hollow-fiber.

To determine flow rates that will allow us to achieve the specified pressure drop of 150 Pa, we first calculate the cross sectional area of the hollow-fiber sorbent bundles using Equation 22 and Equation 23. “Fraction circular path” refers to the fraction of the reactor fluid inlet area that consists of channels through only the inner radius of the hollow-fiber sorbents. “Fraction triangular path” refers to the fraction of the reactor fluid inlet area that consists of the triangular- or three-point-star-shaped channels between the outer circumferences of the hollow-fiber sorbents. The summation of Equation 22 and Equation 23 gives us the “total areal fraction” of the reactor inlet that allows fluid to flow through (Equation 24). The “total areal area” is calculated by multiplying the “total areal fraction” with the “reactor inlet area” (Equation 25). Finally the fluid velocity is calculated by dividing the volumetric flow rate by the cross sectional area (Equation 26).

$$Fraction circular path = ( \frac{C i r cular Path Area}{Unit Cell Area} ) = \frac{\frac{π {r}_{1}^{2}}{2}}{\sqrt{3} {r}_{2}^{2}} \qquad ( Equation 22 )$$

$$Fraction triangular path = ( \frac{\sqrt{3} {r}_{2}^{2} - \frac{π {r}_{2}^{2}}{2}}{\sqrt{3} {r}_{2}^{2}} ) = 1 - \frac{π}{2 \sqrt{3}} \qquad ( Equation 23 )$$

$$Total areal fraction = Fraction circular path + Fraction triangular path \qquad ( Equation 24 )$$

$$Total areal area = ( Total areal fraction ) ( Reactor inlet area ) \qquad ( Equation 25 )$$

$$Air velocity = \frac{Volumetric flow rate}{Cross sectional area} \qquad ( Equation 26 )$$

The areal fraction of the reactor taken up by sorbent is calculated to be 0.27 using Equations 22, 23, and 24, assuming a hollow-fiber outer diameter of 0.9 mm and inner diameter of 0.4 mm. Thus, the area of a 1 m² reactor inlet contains 0.27 m² channels for fluid to flow through. 0.18 m² of this area is the hollow portion of the hollow-fiber sorbent and 0.09 m² of this area is the triangular path between the outer circumferences of the hollow fibers. For 150000 m³ air per hour, the average air velocity through the channels is thus 153 m s⁻¹. Because more air would prefer to flow through the larger channels with less resistance, we find using pressure drop calculations that flow velocities through the cylindrical hollow-portion path is 184 m s⁻¹ and flow velocities through the smaller triangular path to be 94 m s⁻¹.

$$R e = \frac{ρ u {D}_{e q u i v a l e n t}}{μ} \qquad ( Equation 27 )$$

$${A}_{triangular} = {r}_{2}^{2} ( \frac{2 \sqrt{3} - π}{2} ) = {π ( \frac{{D}_{e q u i v a l e n t}}{2} )}^{2} \qquad ( Equation 28 )$$

$${D}_{e q u i v a lent} = 2 \sqrt{{r}_{2}^{2} ( \frac{2 \sqrt{3} - π}{2 π} )} \qquad ( Equation 29 )$$

The Reynolds Number of fluid flow through both the “circular path” and “triangular path” are calculated with Equation 27, where μ is the dynamic viscosity of the fluid, ρ is the density of the fluid, u is the fluid velocity, and D_{equivalent} is the diameter of the flow conduit the fluid is flowing through. For a cylindrical conduit, D_{equivalent} is simply the diameter of the conduit. For any other conduit with a non-circular cross section, we define D_{equivalent} as the diameter of a conduit of equivalent cross sectional area (Equations 28 and Equation 29).

$$R {e}_{triangular} = \frac{ρ u {D}_{e q u i v a l e n t}}{μ} = \frac{( 1.293 \frac{k g}{{m}^{3}} ) ( 94. \frac{m}{s} ) ( 0.0 \; 00204 m )}{18.03 \cdot {10}^{- 6} \frac{N s}{{m}^{2}}} = 1 \; 375 \qquad ( Equation 30 )$$

$$R {e}_{c i r c u l a r} = \frac{ρ u {D}_{e q u i v a l e n t}}{μ} = \frac{( 1.293 \frac{k g}{{m}^{3}} ) ( 183.7 \frac{m}{s} ) ( 0.0 \; 004 m )}{18.03 \cdot {10}^{- 6} \frac{N s}{{m}^{2}}} = 5269 \qquad ( Equation 31 )$$

The Moody Diagram allows us to estimate the coefficient of friction as a function of the Reynolds Number. At Reynolds Numbers below 2000, the flow is laminar and frictional losses decrease with increasing Reynolds Numbers until ˜2000, at which the flow regimes enters a transition region between 2000 and 4000. In this transition region, frictional losses increase by ˜2 to 3 times compared to the laminar region. Above 4000, the flow is completely turbulent and frictional losses depend on both the Reynolds Number and the relative roughness of the walls of the flow conduit. Frictional losses increase pressure drops, requiring pumps, blowers, and fans to use more energy, or requiring engineers to shorten the sorbent length to reduce the pressure drop.

The equivalent diameter of the “triangular pathway” is 0.9 mm for diameter sorbents is 0.2 mm. Equation 30 shows our calculation of the Reynolds Number (Re_{triangular}) through the triangular conduit with an equivalent diameter of 0.2 mm. Equation 31 shows our calculation of the Reynolds Number (Re_{circular}) through the circular interior conduit of the hollow-fiber sorbent with a diameter of 0.4 mm.

The Reynolds Number in the circular conduit of the hollow-fiber sorbent is 1400, which indicates that the flow is laminar. The Reynolds Number in the triangular conduit is 5300, which indicates that the flow is turbulent. From the Moody Diagram, we estimate a conservative value of the coefficient of friction to be ˜0.044. Because the flow is turbulent, we may not be able to accurately use the Hagen-Poiseuille equation, which assumes laminar flow, to estimate pressure drops.

Pressure drops through the triangular and circular regions of the hollow-fiber sorbent are represented by Equations 32 and 33, respectively. f is the friction factor, L is the length of the sorbent bundle, u is the fluid velocity axially through the sorbent bundle, g is the gravitational constant, and D is the equivalent diameter of the conduit shape. The pressure drop across both of these conduit shapes must be equal because the pressure drop across the entire hollow-fiber bundle is a fixed value, as represented by Equation 34. The total volumetric flow rate, \dot{V}, is equal to the sum of the volumetric flow rates through the triangular and circular conduits (Equation 35).

$$Δ {P}_{triangular} = \frac{f L {u}_{t r i a n g u l a r}^{2}}{2 g {D}_{triangular}} \qquad ( Equation 32 )$$

$$Δ {P}_{c i r c u l a r} = \frac{f L {u}_{c i r c u l a r}^{2}}{2 g {D}_{c i r c u l a r}} \qquad ( Equation 33 )$$

$$Δ {P}_{triangular} = Δ {P}_{c i r c u l a r} \qquad ( Equation 34 )$$

$$Volumetric flow rate = \dot{V} = {\dot{V}}_{triangular} + {\dot{V}}_{c i r c u l a r} \qquad ( Equation 35 )$$

For 150 Pa pressure drop, our rods need to be at most 14.5 cm long. This is very long, about an order of magnitude thicker compared to the state-of-the-art for packed powder, which are typically around 2 cm thick. This also means that our reactor geometry cannot be 1×1×1 m³ as the pressure drop will be too high at an estimated 1033 Pa. Instead, our hollow fiber sorbents are able to operate at a pressure drop of 150 Pa at a thickness of 14.5 cm, which corresponds to a real air inlet area of 6.9 m² for an 1 m³ direct air capture reactor.

One of the limiting factors in the cyclic process of capturing and desorbing carbon dioxide is the cycle time. Electrochemistry is promising method to decrease the cycle time by using applied voltages. These applied voltages may be used as a driving force to increase the rate of adsorption and capacity of CO₂ adsorption, and also by using applied voltages by itself or in conjunction with other driving forces such as temperature, pressure, or steam. Proposed geometries in the literature have been limited to flat layers of anodes, electrolyte separators, and cathodes. The literature has also fabricated and tested sorbent around a cylindrical wire to decrease desorption time via resistive heating. During carbon capture, the working electrode, containing the carbon capture sorbent, is typically positively polarized as a cathode. This positive polarization makes the sorbent even more nucleophilic, increasing the driving force to draw in and react with electrophilic carbon dioxide. Once ready for desorption, the polarity is reversed, and the working electrode sorbent becomes the anode and is negatively polarized. This negative polarization makes the sorbent electrophilic, causing it to repel and release carbon dioxide. In a minority of electrochemical systems, anodic polarization may induce the sorbent to uptake carbon dioxide and cathodic polarization may induce the sorbent to release carbon dioxide.

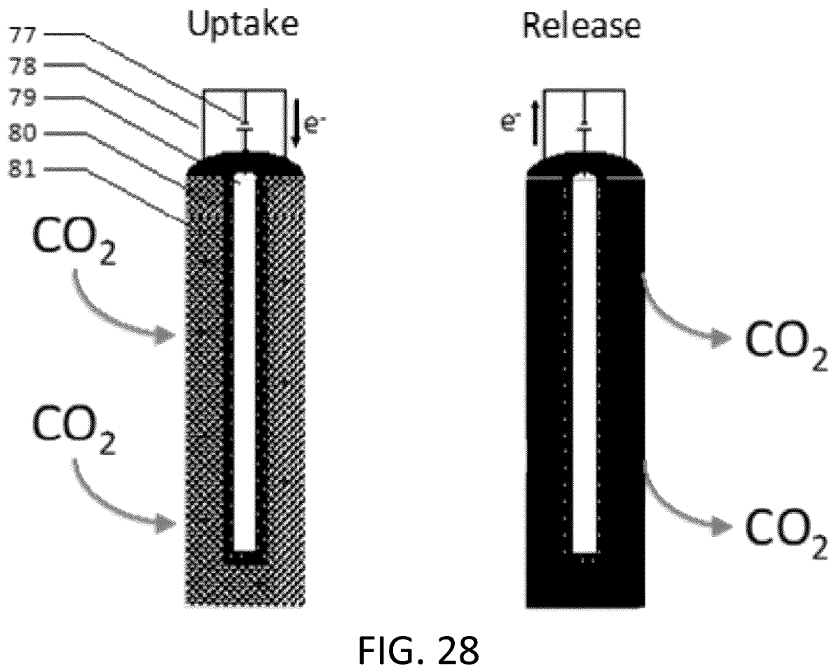

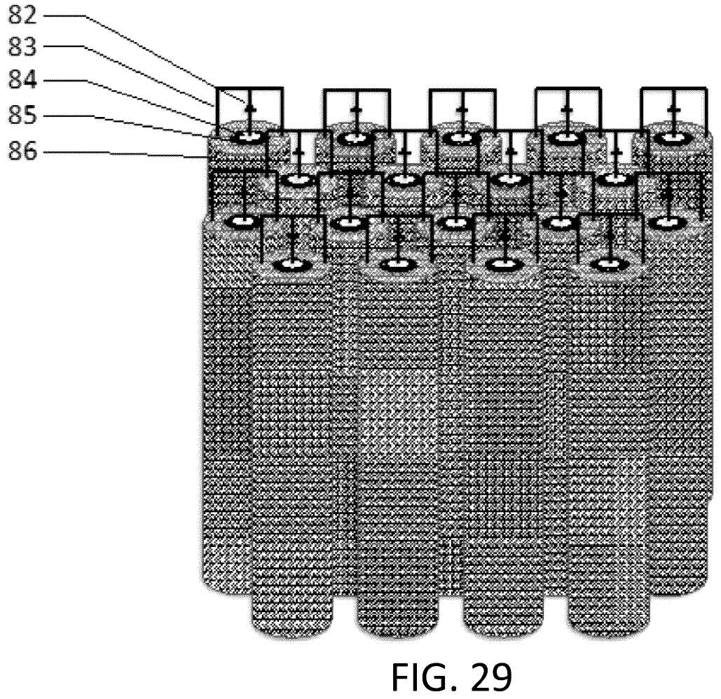

Individual electrochemical sorbents may be manufactured with a paraboloid, silo-shaped, or hollow-fiber-shaped cylinder sorbent filter geometry coated on the inside with a thin electrolyte then filled with an electrode material (FIG. 28). FIG. 28 illustrates an example of how electrochemistry can be used to modulate electron densities in a sorbent to capture and release carbon dioxide. FIG. 28 includes a direct current (DC) voltage source (77), an electrical connection (78), a counter electrode (79), a membrane (80), and a working electrode (81).

These geometries are similar to the “pine needles” in evergreen trees that uptake carbon dioxide. These individual electrochemical sorbents may be bundled together either as a square configuration, triangular configuration, or other similar configurations as described earlier (FIG. 29). FIG. 29 illustrates an example of arranging the sorbent geometry. FIG. 29 includes a DC voltage source (82), an electrical connection (83), a counter electrode (84), a membrane (85), and a working electrode (86).

This bundle configuration has the advantages of rigid channels created naturally from the packing of these sorbent geometries for low pressure drop while increasing the amount of sorbent and its surface area exposed to the fluid. Further, because the sorbent of these geometries will be touching during operation, single point electrochemical failure of individual electrochemical sorbents will still operate as polarization from neighboring electrochemical sorbents (4 neighbors if square-packed up to 6 neighbors if triangular-packed) may assist in polarizing the failed sorbent. The polarization of single-failed electrochemical sorbents is possible with flat sheets, kinked sheets and/or bent sheets arranged in such a way that allows contact between sorbent layers while enabling narrow channels for fluid to flow through.

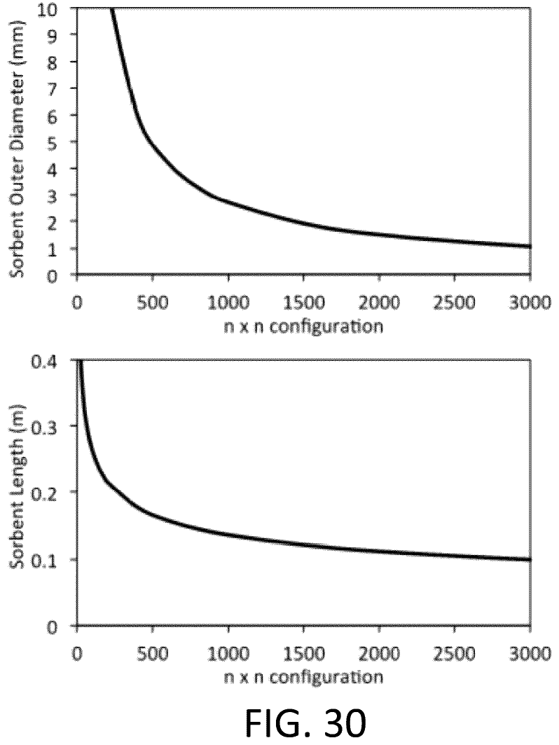

Each cylindrical sorbent consists of one electrode as the center cylinder that serves as the counter electrode, covered by an electrolyte, which is then covered by the outer electrode which serves as the working electrode. We find that, maintaining a reactor volume of 1 m³, air flow rate of 150000 m³ h⁻¹, and a pressure drop of 150 Pa, increasing the n×n bundle configuration results in a decrease in the sorbent outer diameter from 10 mm (1 cm) at a 200×200 configuration, to ˜2 mm (0.2 cm) at a 1500×1500 configuration (FIG. 30 top). To maintain the low pressure drop of 150 Pa as the electrochemical sorbent outer diameter is varied (and consequently the size of the conduits between each electrochemical “pine-needle”), we observe that the sorbent length decreases from ˜0.4 m to nearly leveling out at 0.1 m at high n×n configurations of ˜1 mm in diameter (FIG. 30, bottom).

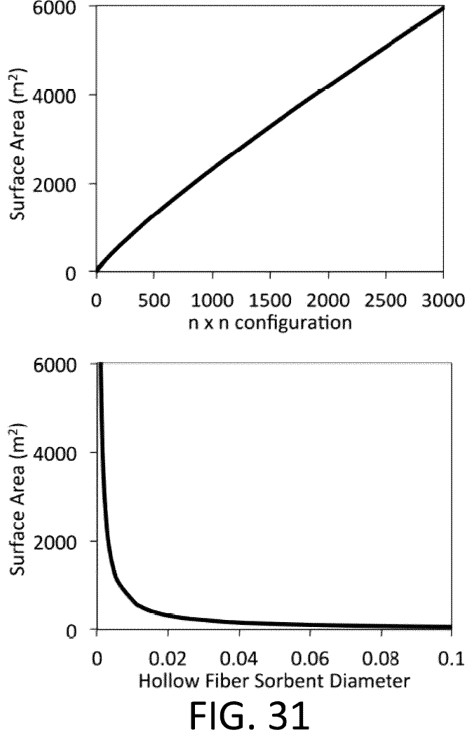

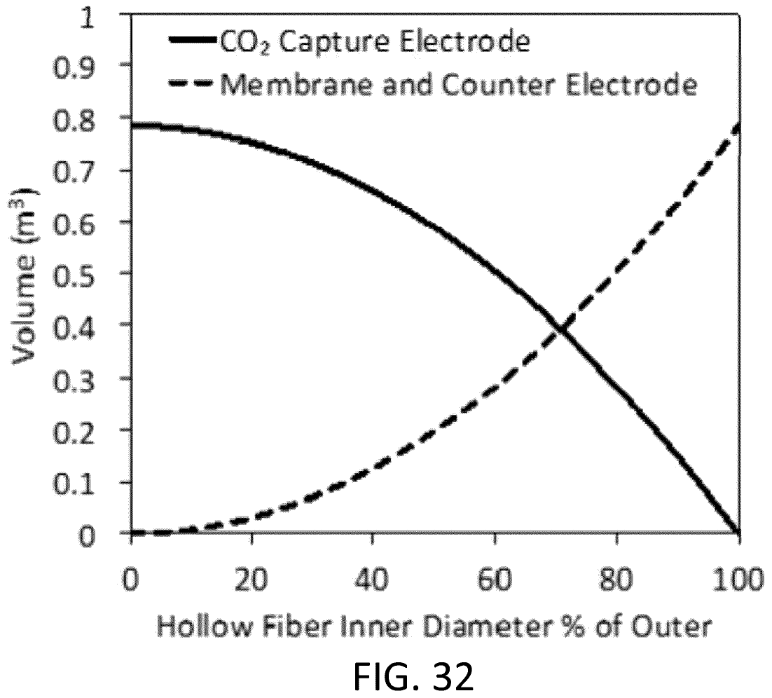

Engineering increases in the surface area exposed to the airflow is one way to increase the carbon dioxide uptake rate. As seen in FIG. 31, this occurs naturally with increasing n×n configurations. Increasing n×n configurations results in not only increases in the number of electrochemical pine needles, but also decreases their diameter, both factors that contribute positively to the exposed surface area. FIG. 32 displays the volume of the carbon dioxide capture sorbent electrode (solid line) and the membrane and counter electrode (dotted line) as a function of the sorbent inner diameter. To optimize electrochemical performance, we desire the reduction and oxidation (capture and release) rates and capacities of the cathode (sorbent) and anode to be as equal as possible. To achieve this, volume ratios of the cathode to the anode may not be equal to 1. FIG. 32 allows us to optimize for the ideal dimensions of the electrochemical paraboloid, silo-shaped, or hollow-fiber-shaped cylinder sorbent filter geometry.

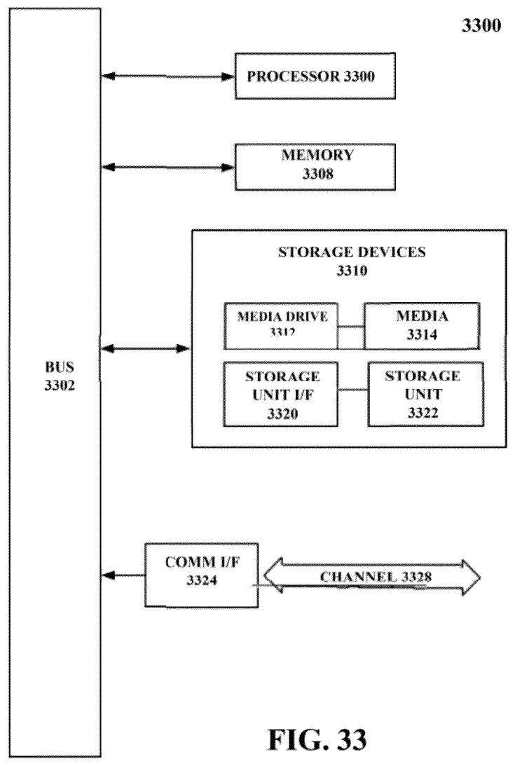

FIG. 33 is a schematic of a controller, according to one example. The controller 3300 includes a processor 3304. The processor 3304 can be implemented using a general-purpose or special-purpose processing engine such as, for example, a microprocessor, controller, or other control logic. The processor 404 can be connected to a bus 3302. However, any communication medium can be used to facilitate interaction with other components of controller 3300 or to communicate externally with the filtration system.

The controller 3300 can also include a main memory 3308. The main memory 3308 can be random access memory (RAM) or other dynamic memory, might be used for storing information and instructions to be executed by processor. Main memory 3308 might also be used for storing temporary variables or other intermediate information during execution of instructions to be executed by processor 3304. The controller 3300 might likewise include a read only memory (“ROM”) or other static storage device coupled to bus 3302 for storing static information and instruction for processor 3304.

The controller 3300 might also include one or more various forms of information storage mechanism 3310, which might include, for example, a media drive 3312 and a storage unit interface 3320. The media drive 3312 might include a drive or other mechanism to support fixed or removable storage media 3314. For example, a hard disk drive, a solid-state drive, a magnetic tape drive, an optical drive, a compact disc (CD) or digital video disc (DVD) drive (R or RW), or other removable or fixed media drive might be provided. Storage media 3314 might include, for example, a hard disk, an integrated circuit assembly, magnetic tape, cartridge, optical disk, a CD or DVD. Storage media 3314 may be any other fixed or removable medium that is read by, written to or accessed by media drive 3312.

As these examples illustrate, the storage media 3314 can include a computer usable storage medium having stored therein computer software or data. In alternative examples, the information storage mechanism 3310 might include other similar instrumentalities or allowing computer programs or other instructions or data to be loaded into the controller 3300. Such instrumentalities might include, for example, a fixed or removable storage unit 3322 and an interface 3320. Examples of such storage units 3322 and interfaces 3320 can include a program cartridge and cartridge interface, a removable memory (for example, a flash memory or other removable memory component) and memory slot. Other examples may include a PCMCIA slot and card, and other fixed or removable storage units 3322 and interfaces 3320 that allow software and data to be transferred from storage unit 3322 to computing component 3300.

The controller 3300 can also include a communications interface 3324. Communications interface 3324 might be used to allow software and data to be transferred between the controller 3300 and external devices. Examples of communications interface 3324 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 3324 may be carried on signals, which can be electronic, electromagnetic (which includes optical) or other signals capable of being exchanged by a given communications interface 3324. These signals might be provided to communications interface 3324 via a channel 3328. Channel 3328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 3308, storage unit 3320, media 3314, and channel 3328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the controller 3300 to perform features or functions of the present application as discussed herein. It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described examples.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A sorbent filter for filtering at least one of an axial, radial, and perpendicular flow of at least one of a gas, plasma, liquid, and solid particulates, the sorbent filter comprising:
a support material;
a binder material for binding one or more active chemical materials from a functional group to the support material; and
a filter body comprising:
a height of the filter body longer than a radius of the filter body, the radius extending from a center axis through the filter body; and
an inner surface having a thickness less than the radius.

2. The sorbent filter of claim 1, wherein the filter body comprises at least one of: an open-ended paraboloid; a closed-ended paraboloid; a silo-shaped geometry; a conical-shaped geometry; and cylindrical-shaped geometry.

3. The sorbent filter of claim 1, wherein the filter body further comprises an outer surface in contact with at least one electrolyte and electrode for transmitting a voltage to the filter body.

4. The sorbent filter of claim 1, wherein the one or more active chemical material contains anime, hydroxide, or oxide functional groups designed to uptake carbon dioxide.

5. The sorbent filter of claim 1, wherein the filter body further comprises one or more metallic centers designed to uptake carbon dioxide.

6. The sorbent filter of claim 5, wherein the one or more metallic centers is in combination with one or more active chemical materials is designed to uptake carbon dioxide.

7. The sorbent filter of claim 6, wherein the active chemical group comprises at least one of: (i) a hydroxide group, (ii) an oxide group, (iii) an amine group, and (iv) a combination thereof.

8. The sorbent filter of claim 7, wherein the one or more active chemical material uptakes carbon dioxide via: (i) electron transfer to or from a carbon atom, (ii) electron transfer to or from an oxygen atom; (iii) pi complexation; and (iv) combinations thereof.

9. The sorbent filter of claim 8, wherein the support material comprises: (i) a metal, (ii) a mineral, (iii) a ceramic, (iv) a polymer, (v) biomaterial, (vi) inorganic allotropes; and (vii) combinations thereof.

10. The sorbent filter of claim 9, wherein the binder material includes at least one of: (i) a metal, (ii) a mineral, (iii) a ceramic, (iv) a polymer, (v) a biomaterial, (vi) inorganic allotropes; and (vii) combinations thereof.

11. The sorbent filter of claim 10, further comprising a working electrode that transports ionic species to or from an electrolyte to: (i) chemically react the carbon dioxide, or (ii) physical or chemically absorb the carbon dioxide.

12. The sorbent filter of claim 11, further comprising a counter electrode comprising the one or more active chemical material for delivering or receiving the ionic species to the electrolyte for transport to or from the working electrode.

13. The sorbent filter of claim 12, further comprising a reference electrode comprising the one or more active chemical material for up-taking and releasing electrons.

14. The sorbent filter of claim 13, comprising at least one electrolyte material for enabling transport of an ionic species to physically separate two or more electrodes and ensure a firm chemical and physical interface between the at least one electrolyte material and two or more electrodes.

15. The sorbent filter of claim 14, further comprising an outer surface, that does not contact at least one of: the at least one electrolyte material, the counter electrode, the reference electrode.

16. The sorbent filter of claim 14, wherein the ionic species include at least one of: (i) cationic species, and (ii) anionic species.

17. The sorbent filter of claim 16, wherein the one or more active materials comprise at least one of: (i) physical mixture; (ii) chemically bound mixture; (iii) layered configurations; (iv) rolled configurations; (v) woven configurations; (vi) a combination thereof.

18. The sorbent filter of claim 1, wherein the sorbent filter comprises at least one of: (i) paraboloid-shaped body, (ii) silo-shaped body, (iii) conical-shaped body, (iv) cylindrical-shaped body; (v) a combination thereof.

19. A filter housing for filtering carbon dioxide from a gaseous flow, the filter bundle housing comprising:
a plurality of fibered filters disposed in the filter housing, wherein the plurality of fibered filters includes a first fibered filter being in physical contact with a second fibered filter; and
a casing for containing the plurality of close-ended hollow fibered filters, the casing having: an inner portion for filter components, and an outer portion for reactor tubing and reactor ports.

20. (canceled)

21. The filter housing of claim 19, wherein the outer portion comprises a solid material comprising at least one of: (i) a metal; (ii) a ceramic material; (iii) a polymer material; (iv) a biomaterial; and (v) a combination thereof;
wherein the filter housing further includes electrical elements for at least one of: (i) heating; (ii) valves; (iii) sensors; (iv) flow devices; (v) blowers; (vi) electrochemical devices; and (vii) combinations thereof;
wherein the gaseous flow comprises carbon dioxide flowing through tubing or piping between reactor operations; and
wherein the filter bundle housing is applied to at least one of: (i) a direct air capture device, (ii) a fan; (iii) a dehumidifier; (iv) a humidifier; (v) a heat exchanger; (vi) a heat pump; (vii) a compressor; (viii) a vacuum pump; and (ix) a gas absorber.

22. (canceled)

23. (canceled)

24. (canceled)

25. (canceled)

26. (canceled)

27. (canceled)
